(19) United States
(12) Patent Application Publication
(10) Pub. No.: US 2015/0248275 A1
(43) Pub. Date: Sep. 3, 2015

(54) Sensor Grouping for a Sensor Based Detection System

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E. K. de Antoni, Manila (PH); Scott Gill, Makati (PH); Daniel Stellick, Geneva, IL (US)

(21) Appl. No.: 14/336,994

(22) Filed: Jul. 21, 2014

Related U.S. Application Data
(63) Continuation-in-part of application No. 14/281,896, filed on May 20, 2014.
Application No. 14/281,896 is a continuation-in-part of application No. 14/281,901, filed on May 20, 2014.
Application No. 14/281,901 is a continuation-in-part of application No. 14/315,286, filed on Jun. 25, 2014.
Application No. 14/315,286 is a continuation-in-part of application No. 14/315,289, filed on Jun. 25, 2014.
Application No. 14/315,289 is a continuation-in-part of application No. 14/315,317, filed on Jun. 25, 2014.
Application No. 14/315,317 is a continuation-in-part of application No. 14/315,320, filed on Jun. 25, 2014.
Application No. 14/315,320 is a continuation-in-part of application No. 14/315,322, filed on Jun. 25, 2014.
Application No. 14/315,322 is a continuation-in-part of application No. 14/337,012, filed on Jul. 21, 2014.
Application No. 14/337,012 is a continuation-in-part of application No. 14/284,009, filed on May 21, 2014.
Application No. 14/284,009 is a continuation-in-part of application No. 14/281,904, filed on May 20, 2014.

(30) Foreign Application Priority Data
May 23, 2013 (PH) 1-2013-000136

(51) Int. Cl. G06F 7/00

(52) U.S. Cl. CPC G06F 7/00

(57) ABSTRACT

Provided is a method including receiving data associated with a first detection sensor; receiving data associated with a second detection sensor; and grouping the first detection sensor and the second detection sensor together if the data associated with the first detection sensor satisfies a first condition and if the data associated with the second sensor detection sensor satisfies a second condition.

### RELATED APPLICATIONS

This application is related to U.S. patent application Ser. No. 14/281,896, titled “Sensor Based Detection System,” by Joseph L. Gallo et al. (Attorney Docket No. 13-012-00-US), filed May 20, 2014, which application is incorporated herein by reference in its entirety and claims the benefit and priority thereto.

This application is related to U.S. patent application Ser. No. 14/281,901, titled “Sensor Based Detection Management Platform,” by Joseph L. Gallo et al. (Attorney Docket No. 13-013-00-US), filed May 20, 2014, which application is incorporated herein by reference in its entirety and claims the benefit and priority thereto.

This application is related to U.S. patent application Ser. No. 14/315,286, titled “Method and System for Representing Sensor Associated Data,” by Joseph L. Gallo et al. (Attorney Docket No. 13-014-00-US), filed Jun. 25, 2014, which application is incorporated herein by reference in its entirety and claims the benefit and priority thereto.

This application is related to U.S. patent application Ser. No. 14/315,289, titled “Method and System for Sensor Associated Messaging,” by Joseph L. Gallo et al. (Attorney Docket No. 13-015-00-US), filed Jun. 25, 2014, which application is incorporated herein by reference in its entirety and claims the benefit and priority thereto.

This application is related to U.S. patent application Ser. No. 14/315,317, titled “Path Determination of a Sensor Based Detection System,” by Joseph L. Gallo et al. (Attorney Docket No. 13-016-00-US), filed Jun. 25, 2014, which application is incorporated herein by reference in its entirety and claims the benefit and priority thereto.

This application is related to U.S. patent application Ser. No. 14/315,320, titled “Graphical User Interface of a Sensor Based Detection System,” by Joseph L. Gallo et al. (Attorney Docket No. 13-017-00-US), filed Jun. 25, 2014, which application is incorporated herein by reference in its entirety and claims the benefit and priority thereto.

This application is related to U.S. patent application Ser. No. 14/315,322, titled “Graphical User Interface for Path Determination of a Sensor Based Detection System,” by Joseph L. Gallo et al. (Attorney Docket No. 13-018-00-US), filed Jun. 25, 2014, which application is incorporated herein by reference in its entirety and claims the benefit and priority thereto.

This application is related to U.S. patent application Ser. No. 14/281,904, titled “Event Management System for a Sensor Based Detection System,” by Joseph L. Gallo et al. (Attorney Docket No. 13-020-00-US), filed May 20, 2014, which application is incorporated herein by reference in its entirety and claims the benefit and priority thereto.

This application is related to U.S. patent application Ser. No. 14/284,009, titled “User Query and Gauge-Reading Relationships,” by Joseph L. Gallo et al. (Attorney Docket No. 13-027-00-US), filed May 21, 2014, which application is incorporated herein by reference in its entirety and claims the benefit and priority thereto.

This application is related to Philippines Patent Application No. 1/2013/000136, titled “A Domain Agnostic Method and System for the Capture, Storage, and Analysis of Sensor Readings,” by Joseph L. Gallo et al. (Attorney Docket No. 13-027-00-PH), filed May 23, 2013, which application is incorporated herein by reference in its entirety and claims the benefit and priority thereto.

This application is related to U.S. patent application No. ______ entitled “Data Structure for a Sensor Based Detection Sensors”, by Joseph L. Gallo et al. (Attorney Docket No. 13-022-00-US) and filed concurrently herewith on ______ and incorporated by reference herein

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the gathered information is used for marketing and advertising to the end user, e.g., smartphone user receives a coupon to a nearby coffee shop, etc., while the security of our community is left exposed and at a risk of terrorist attacks such as the Boston Marathon bombers.

### SUMMARY

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security. For example, relevant information of the sensors may be gathered by grouping sensors together based on readings of the sensors relative to a condition, threshold, or heuristics. The grouping of sensors may allow for efficient monitoring of the sensors by interested parties.

According to some embodiments, data associated with a number of sensors are received. The data of the sensors may be compared to a certain condition, for example a threshold value, and based on the comparison, two or more of the sensors may be grouped together. In some embodiments, the grouping of sensors may include combining the data and metadata of the sensors in a data structure.

According to some embodiments, data associated with a first detection sensor and data associated with a second detection sensor is received. The first detection sensor and the second detection sensor are grouped together if the data associated with the first detection sensor satisfies a first condition and if the data associated with the second sensor detection sensor satisfies a second condition.

According to some embodiments, a data store is configured to store data associated with a first and second detection sensor. Furthermore, a state change manger is configured to determine whether the data of the first detection sensor satisfies a first condition and the second detection sensor satisfies a second condition. A sensor data representation module is configured to group the first detection sensor and the second radiation detection sensor together based on the determination that the data of the first and second radiation detection sensors satisfy the first and second conditions, respectively.

According to some embodiments, data associated with a first detection sensor is receiving and a second detection sensor is identifying based on data second sensor satisfying a certain condition. The first detection sensor is grouped together with the identified second radiation detection sensor.

These and other features and aspects may be better understood with reference to the following drawings, description, and appended claims.

### BRIEF DESCRIPTION OF DRAWINGS

FIG. 1 illustrates an operating environment according to some embodiments.

FIG. 2 illustrates a data flow diagram according to some embodiments.

FIGS. 3-6 illustrate automated groupings of sensors according to some embodiments.

FIGS. 7-8 illustrate manual groupings of sensors according to some embodiments.

FIGS. 9-14 illustrate map views for sensors according to some embodiments.

FIG. 15 illustrates data interactions within a sensor based detection system according to some embodiments.

FIG. 16 illustrates a flow chart diagram for grouping sensors according to some embodiments.

FIG. 17 illustrates another flow chart diagram for grouping sensors according to some embodiments.

FIG. 18 illustrates other data interactions within a sensor based detection system according to some embodiments.

FIG. 19 illustrates a flow chart diagram for manually grouping sensors according to some embodiments.

FIG. 20 illustrates another flow chart diagram for manually grouping sensors according to some embodiments.

FIG. 21 illustrates a computer system according to some embodiments.

FIG. 22 illustrates a block diagram of another computer system according to some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “identifying,” “grouping,” “ungrouping,” “rendering,” “determining,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Provided herein are embodiments for grouping/ungrouping multiple sensors of a sensor-based system. The sensors are configured for monitoring certain conditions, e.g., radiation levels, acoustic threshold, moisture, or play back of events. For example, the sensor-based system include any of a variety of sensors, including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), biological/chemical (e.g., toxins, nutrients, etc.), or any combination thereof. The sensor-based system may further include any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal-based portal sensors, biochemical, pressure, air quality, water quality, fire, flood, intrusion detection, motion detection, particle count, water level, or surveillance cameras. The grouping of sensors may be based on various conditions, e.g., proximity of sensors to one another, geo-location of the sensors and their particular location, type of sensor, range of sensor detection, physical proximity of sensors, floor plan of a structure where the sensor is positioned or is next to, etc. In some embodiments, the system for grouping of sensors may provide functionality to alert appropriate entities or individuals to the status of events captured by the sensor-based system as events evolve, either in real-time or based on recorded sensor data.

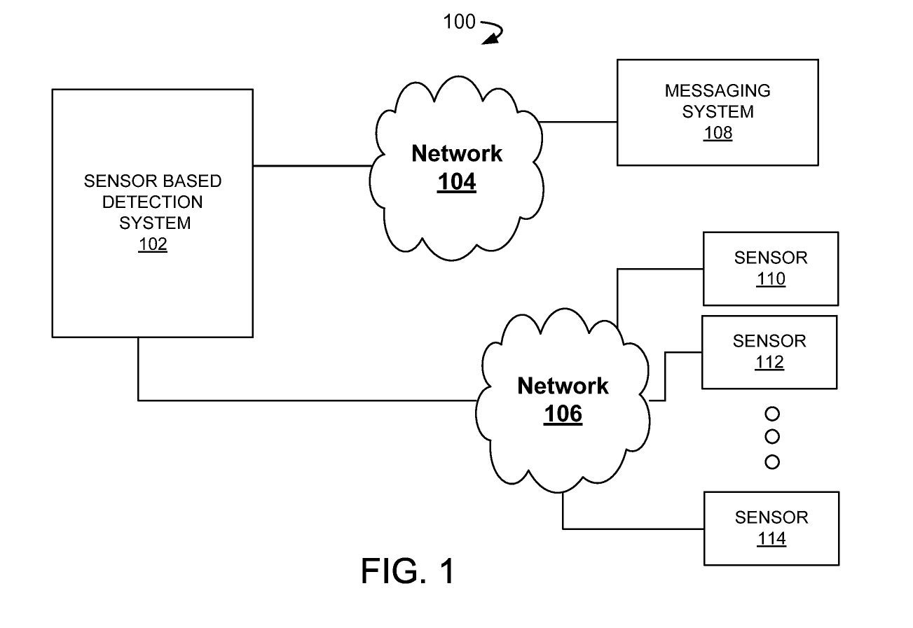

FIG. 1 shows an operating environment according to some embodiments.

Exemplary operating environment 100 includes a sensor based detection system 102, a network 104, a network 106, a messaging system 108, and sensors 110-114. The sensor based detection system 102 and the messaging system 108 are coupled to a network 104. The sensor based detection system 102 and messaging system 108 are communicatively coupled via the network 104. The sensor based detection system 102 and sensors 110-114 are coupled to a network 106. The sensor based detection system 102 and sensors 110-114 are communicatively coupled via network 106. Networks 104, 106 may include more than one network (e.g., intranets, the Internet, local area networks (LANs), wide area networks (WANs), etc.) and may be a combination of one or more networks including the Internet. In some embodiments, network 104 and network 106 may be a single network.

The sensors 110-114 detect a reading associated therewith, e.g., gamma radiation, vibration, etc., and transmit that information to the sensor based detection system 102 for analysis. The sensor based detection system 102 may use the received information and compare it to a threshold value, e.g., historical values, user selected values, etc., in order to determine whether a potentially hazardous event has occurred. In response to the determination, the sensor based detection system 102 may transmit that information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-114 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-114 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, surveillance cameras, etc. The sensors 110-114 may be video cameras (e.g., internet protocol (IP) video cameras) or purpose built sensors.

The sensors 110-114 may be fixed in location (e.g., surveillance cameras or sensors), semi-fixed (e.g., sensors on a cell tower on wheels or affixed to another semi portable object), or mobile (e.g., part of a mobile device, smartphone, etc.). The sensors 110-114 may provide data to the sensor based detection system 102 according to the type of the sensors 110-114. For example, sensors 110-114 may be CMOS sensors configured for gamma radiation detection. Gamma radiation may thus illuminate a pixel, which is converted into an electrical signal and sent to the sensor based detection system 102.

The sensor based detection system 102 is configured to receive data and manage sensors 110-114. The sensor based detection system 102 is configured to assist users in monitoring and tracking sensor readings or levels at one or more locations. The sensor based detection system 102 may have various components that allow for easy deployment of new sensors within a location (e.g., by an administrator) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-114 and components of a sensor based detection system 102 may be distributed over multiple systems (e.g., and virtualized) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, etc., and if so then the sensor based detection system 102 may determine a route or path of travel that dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, etc., or relative to a mixture of fixed and mobile sensors may similarly be determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-114. The GUI may be configured for indicating sensor readings, sensor status, sensor locations on a map, etc. The sensor based detection system 102 may allow review of past sensor readings and movement of sensor detected material or conditions based on stop, play, pause, fast forward, and rewind functionality of stored sensor values. The sensor based detection system 102 may also allow viewing of an image or video footage (e.g., motion or still images) corresponding to sensors that had sensor readings above a threshold (e.g., based on a predetermined value or based on ambient sensor readings). For example, a sensor may be selected in a GUI and video footage associated with an area within a sensor's range of detection may be displayed, thereby enabling a user to see an individual or person transporting hazardous material. According to one embodiment the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensors representations and/or indicators which may include, color coded, shapes, icons, flash rate, etc., according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the GUI. The sensor based detection system 102 may allow a user (e.g., operator) to group multiple sensors together to create an event associated with multiple alerts from multiple sensors. For example, a code red event may be created when three sensors or more within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-114. The messaging system 108 may include one or more messaging systems or platforms which may include a database (e.g., messaging, SQL, or other database), short message service (SMS), multimedia messaging service (MMS), instant messaging services, TWITTER available from Twitter, Inc. of San Francisco, Calif., Extensible Markup Language (XML) based messaging service (e.g., for communication with a Fusion center), JAVASCRIPT Object Notation (JSON) messaging service, etc. For example, national information exchange model (NIEM) compliant messaging may be used to report chemical, biological, radiological and nuclear defense (CBRN) suspicious activity reports (SARs) to government entities (e.g., local, state, or federal government).

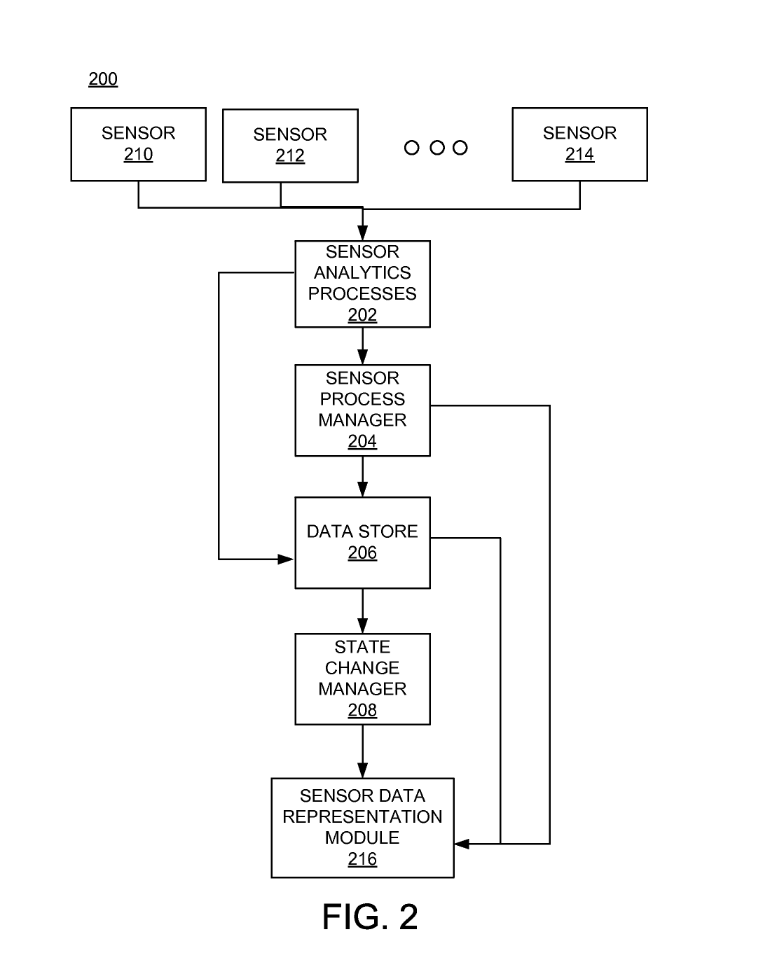

FIG. 2 illustrates a data flow diagram according to some embodiments. Diagram 200 depicts the flow of data (e.g., sensor readings, raw sensor data, analyzed sensor data, etc.) associated with a sensor based detection system (e.g., sensor based detection system 102). Diagram 200 includes sensors 210-214, sensor analytics processes 202, a sensor process manager 204, a data store 206, a state change manager 208, and a sensor data representation module 216. In some embodiments, the sensor analytics processes 202, the sensor process manager 204, the state change manager 208, and the sensor data representation module 216 may execute on one or more computing systems (e.g., virtual or physical computing systems). The data store 206 may be part of or stored in a data warehouse. Sensors 210-214 are similar to sensors 110-114 operate substantially similar thereto. It is appreciated that the sensors may be associated with their geographic locations. Sensors 210-214 may be used to collect information, for example acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, etc. The sensors 210-214 may provide data (e.g., sensor readings, such as camera stream data, video stream data, etc.) to the sensor analytics processes 202.

The sensor process manager 204 receives analyzed sensor data from sensor analytics processes 202. The sensor process manager 204 may then send the analyzed sensor data to the data store 206 for storage. The sensor process manager 204 may further send metadata associated with sensors 210-214 for storage in the data store 206 with the associated analyzed sensor data. In some embodiments, the sensor process manager 204 may send the analyzed sensor data and metadata to the sensor data representation module 216. In some embodiments, the sensor process manager 204 sends the analyzed sensor data and metadata associated with sensors 210-214 to the sensor data representation module 216. It is appreciated that the information transmitted to the sensor data representation module 216 from the sensor process manager 204 may be in a message based format.

The sensor process manager 204 is configured to initiate or launch sensor analytics processes 202. The sensor process manager 204 is operable to configure each instance or process of the sensor analytics processes 202 based on configuration parameters (e.g., preset, configured by a user, etc.). In some embodiments, the sensor analytics processes 202 may be configured by the sensor process manager 204 to organize sensor readings over time intervals (e.g., 30 seconds, one minute, one hour, one day, one week, one year). It is appreciated that the particular time intervals may be preset or it may be user configurable. It is further appreciated that the particular time intervals may be changed dynamically, e.g., during run time, or statically. In some embodiments, a process of the sensor analytics processes 202 may be executed for each time interval. The sensor process manager 204 may also be configured to access or receive metadata associated with sensors 210-214 (e.g., geospatial coordinates, network settings, user entered information, etc.).

In some embodiments, sensor analytics processes 202 may then send the analyzed sensor data to the data store 206 for storage. The sensor analytics processes 202 may further send metadata associated with sensors 210-214 for storage in the data store 206 with the associated analyzed sensor data.

The state change manager 208 may access or receive analyzed sensor data and associated metadata from the data store 206. The state change manager 208 may be configured to analyze sensor readings for a possible change in the state of the sensor. It is appreciated that in one embodiment, the state change manager 208 may receive the analyzed sensor data and/or associated metadata from the sensor analytics processes 202 directly without having to fetch that information from the data store 206 (not shown).

The state change manager 208 may determine whether a state of a sensor has changed based on current sensor data and previous sensor data. Changes in sensor state based on the sensor readings exceeding a threshold, within or outside of a range, etc., may be sent to a sensor data representation module 216 (e.g., on a per sensor basis, on a per group of sensors basis, etc.). For example, a state change of the sensor 212 may be determined based on the sensor 212 changing from a prior normal reading to an elevated reading (e.g., above a certain threshold, within an elevated reading, within a dangerous reading, etc.) In another example, the state of sensor 210 may be determine not to have changed based on the sensor 212 having an elevated reading within the same range as the prior sensor reading.

In some embodiments, the sensor process manager 204 may configure various states of sensors and associated alerts may be configured therein. For example, the sensor process manager 204 may be used to configure thresholds, ranges, etc., that may be compared against sensor readings to determine whether an alert should be generated. For example, the sensors 210-214 may have five possible states: calibration, nominal, elevated, potential, and warning. It is appreciated that the configuring of sensor process manager 204 may be in response to a user input. For example, a user may set the threshold values, ranges, etc., and conditions to be met for generating an alert. In some embodiments, color may be associated with each state. For example, dark gray may be associated with a calibration state, green associated with a nominal state, yellow associated with an elevated state, orange associated with a potential state, and red associated with an alert state. Light gray may be used to represent a sensor that is offline or not functioning. It is appreciated that any number of states may be present and discussing five possible states is for illustrative purposes and not intended to limit the scope of the embodiments.

In some embodiments, the state change manager 208 is configured to generate an alert or alert signal if there is a change in the state of a sensor 210-214 to a new state. For example, an alert may be generated for a sensor that goes from a nominal state to an elevated state or a potential state. In some embodiments, the state change manager 208 includes an active state table. The active state table may be used to store the current state and/or previous and thereby the active state table is maintained to determine state changes of the sensors 210-214. The state change manager 208 may thus provide real-time sensing information based on sensor state changes.

In some embodiments, the state change manager 208 may determine whether sensor readings exceed normal sensor readings from ambient sources or whether there has been a change in the state of the sensor and generate an alert. For example, with gamma radiation, the state change manager 208 may determine if gamma radiation sensor readings are from a natural source (e.g., the sun, another celestial source, etc.) or other natural ambient source based on a nominal sensor state, or from radioactive material that is being transported within range of a sensor based on an elevated, potential, or warning sensor state. In one exemplary embodiment, it is determined whether the gamma radiation reading is within a safe range based on a sensor state of nominal or outside of the safe range based on the sensor state of elevated, potential, or warning.

In some embodiments, individual alerts may be sent to an external system (e.g., a messaging system 108). For example, one or more alerts that occur in a certain building within time spans of one minute, two minutes, or 10 minutes may be sent to a messaging system. It is appreciated that the time spans that the alerts are transmitted may be preset or selected by the system operator. In one embodiment, the time spans that the alerts are transmitted may be set dynamically, e.g., in real time, or statically.

The sensor data representation module 216 may access or receive analyzed sensor data and associated metadata from the sensor process manager 204 or data store 206. The sensor data representation module 216 may further receive alerts (e.g., on a per sensor basis, on per location basis, etc.) based on sensor state changes determined by the state change manager 208.

The sensor data representation module 216 may be operable to render a graphical user interface (GUI) depicting sensors 210-214, sensor state, alerts, sensor readings, etc. Sensor data representation module 216 may display one or more alerts, which occur when a sensor reading satisfies a certain condition visually on a map, e.g., when a sensor reading exceeds a threshold, falls within a certain range, is below a certain threshold, etc. The sensor data representation module 216 may thus notify a user (e.g., operator, administrator, etc.) visually, audibly, etc., that a certain condition has been met by the sensors, e.g., possible bio-hazardous material has been detected, elevated gamma radiation has been detected, etc. The user may have the opportunity to inspect the various data that the sensor analytics processes 202 have generated (e.g. mSv values, bio-hazard reading level values, etc.) and generate an appropriate event case file including the original sensor analytics process 202 data (e.g., raw stream data, converted stream data, preprocessed sensor data, etc.) that triggered the alert. The sensor data representation module 216 may be used (e.g., by operators, administrators, etc.) to gain awareness of any materials (e.g., radioactive material, bio-hazardous material, etc.) or other conditions that travel through or occur in a monitored area.

In some embodiments, the sensor data representation module 216 includes location functionality operable to show a sensor, alerts, and events geographically. The location functionality may be used to plot the various sensors at their respective location on a map within a GUI. The GUI may allow for visual maps with detailed floor plans at various zoom levels, etc. The sensor data representation module 216 may send sensor data, alerts, and events to a messaging system (e.g., messaging system 108) for distribution (e.g., other users, safety officials, etc.).

As described below, sensor data representation module 216 may group multiple sensors together or ungroup one or more sensors from a previously created grouping. Herein, reference to grouping may refer to an aggregation of sensor captured data, metadata associated with multiple sensors 210-214, etc. Additionally, reference to ungrouping may refer to detaching one or more sensors 210-214 from a previously formed grouping of sensors 210-214. As an example, sensor data representation module 216 may ungroup sensor 212 from a grouping of sensors 210-214 by removing data corresponding to sensor 212 from the data structure of the grouping. As an example, sensor data representation module 216 may form a grouping of sensors, e.g., 210-214 by creating a data structure that aggregates readings from sensors 210-214 of the grouping, a data structure that aggregates reading from sensors, but displays the highest reading, a data structure that aggregates readings from sensors but displays the average reading of the sensor grouping, a data structure that aggregates readings from sensors and displays metadata associated such as geo-positional information, etc. As another example, sensor data representation module 216 may form a grouping of sensors, e.g., 210-214 by creating a data structure that aggregates readings from sensors 210-214 of the grouping having similar characteristics, e.g., similar sensors, sensors with similar state, sensors with similar metadata, sensors with similar readings, etc.

The created data structure may be stored in data store 206. In some embodiments, sensor data representation module 216 may group sensors 210-214 in the data structure using a MapReduce framework. The data structure may describe a grouping of sensors 210-214 with respect to any parameter associated therewith, e.g., location, sensor data, type, etc. As an example, the data structure of the grouping may be stored locally or in data store 206 as a relational database. The data structure may be a hierarchy of entries and each entry may have one or more sub-entries. For example, entries in the data structure may correspond to the individual sensors and the sub-entries may be the metadata of the individual sensors. As another example, a sub-entry may be the sensed data of the individual sensors. Entries in the data structure may implemented as JSON or XML documents that have attribute-value pairs. For a sensor, an example attribute may be “location” and a corresponding value may be “Terminal A”.

The data structure may include sensor readings of sensors 210-214 captured over a fixed time scale (e.g., period of time). In some embodiments, sensor readings may be added to the data structure starting at a time that is determined based on the sensor readings of sensors of the grouping 210-214. As an example, the sensor readings included in the data structure may start at a time when one or more of sensors 210-214 has an elevated reading. As another example, the sensor readings included in the data structure may start at a time when one or more of sensors 210-214 has a reading within a threshold. In other embodiments, the data structure of grouped sensors 210-214 may be open ended and may add readings from sensors 210-214 in an on-going basis until an operator manually closes out the data collection or automatically based on heuristics. For example, sensor readings of a grouping of sensors may be discontinued when all sensors 210-214 of the grouping no longer have elevated readings, readings of the sensors are within a certain range, etc.

The data structure may allow adding or removing an entry at any time. As an example, sensor data representation module 216 may access or receive one or more conditions, parameters, or heuristics via a graphical user interface, as input by an operator for instance, that may be used to configure sensor data representation module 216. The user input information accessed by sensor data representation module 216 may be used to group or ungroup sensors 210-214. The conditions, parameters, or heuristics may be received via the graphical user interface of a sensor data representation module 216, a sensor process manager 204, state change manager 208, etc. As described below, sensor data representation module 216 may determine grouping or ungrouping of sensors 210-214 based on an evaluation (e.g., a comparison, an algorithm, etc.) of sensor data, sensor metadata, or the conditions, parameters, heuristics, etc. For example, a sensor previously not included in an existing sensor grouping and satisfying a certain condition may be added to the existing sensor grouping by adding an entry corresponding to the sensor into the data structure. Furthermore, a sensor in the existing sensor grouping that no longer satisfies a certain condition may be removed from the existing sensor grouping by removing the entry corresponding to the sensor from the data structure.

Furthermore, data associated with a sensor grouping may be used to generate messages, monitor readings from sensors 210-214 of the sensor grouping, visualize the status or location of sensors 210-214 of the sensor grouping, etc. In some embodiments, a grouping of sensors 210-214 may group the sensed data (readings) of sensors 210-214 in a data structure. Although this disclosure describes grouping and ungrouping of sensors using a data structure, this disclosure contemplates any suitable grouping and ungrouping of sensors using any suitable data structure.

An indicator may be output from the sensor data representation module 216 based on determining that a grouping of sensors 210-214. In some embodiments, the indicator may be output visually, audibly, or via a signal to another system (e.g., messaging system 108). As described below, groups of sensors may be selected manually (e.g., via a GUI, command line interface, etc.) or automatically (e.g., based on an automatic grouping determined by the sensor based detection system 102) based on heuristics. In some embodiments, the indicator (e.g., alert, event, message, etc.) may be output to a messaging system (e.g., messaging system 108). For example, the indicator may be output to notify a person (e.g., operator, administrator, safety official, etc.) or group of persons (e.g., safety department, police department, fire department, homeland security, etc.).

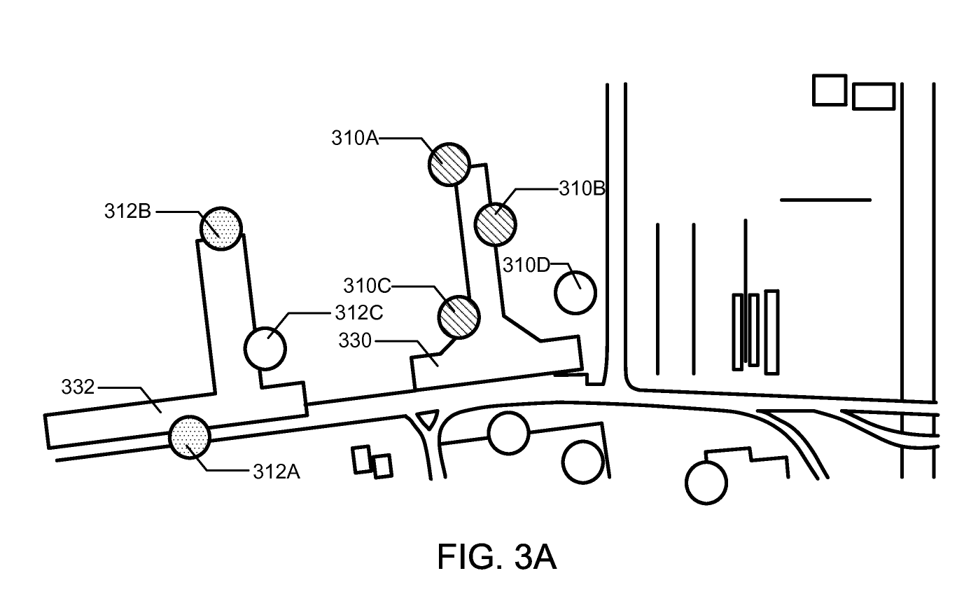

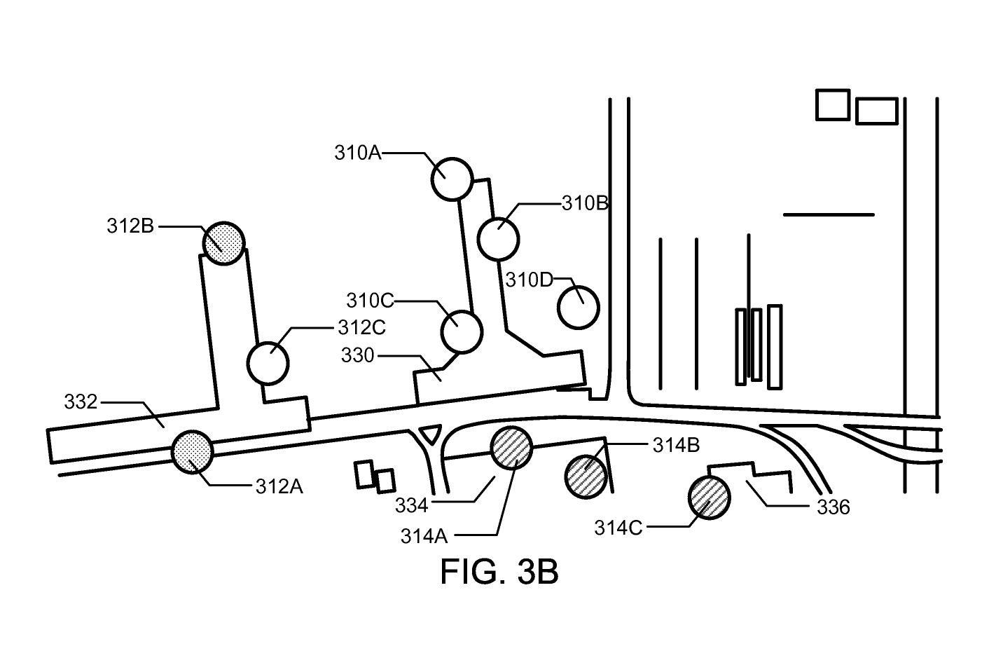

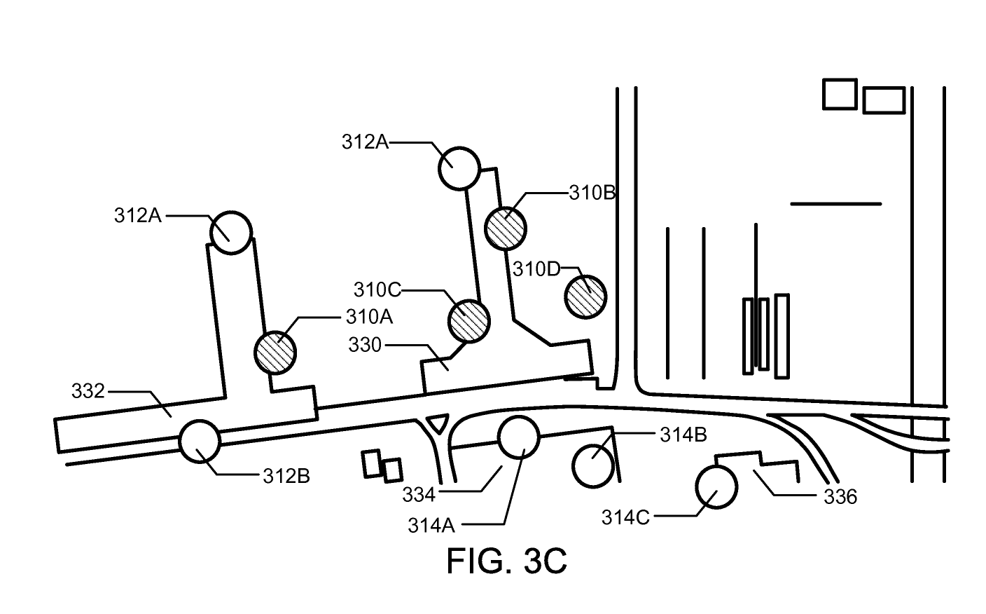

FIGS. 3A-C illustrate automated groupings of sensors according to some embodiments. As described above, sensor data representation module 216 may determine a grouping of sensors. In some embodiments, the grouping may be based on the data or readings of sensors, metadata of sensors, one or more conditions, parameters, heuristics, etc. For example, sensors may be grouped based on their readings, all of which may be elevated. On the other hand, another grouping of sensors may be grouped together based on their reading being highly elevated. As another example, sensors with metadata having substantially similar values may be grouped together. On the other hand, sensors with metadata within a range of values may be grouped together. Metadata of sensors may include, but are not limited to, building name, floor level, room number, geospatial (e.g., geographic information system (GIS)) coordinates within a given range (e.g., distance between sensors, proximity of sensors to a location, etc.), sensor vendors, sensor type, sensor properties, sensor configuration, etc.

In some embodiments, sensor data representation module 216 may group sensors together based on metadata showing the sensors are located within a geographic location, for example structure, city, county, region, etc. As illustrated in FIG. 3A, sensors 310A-C may be automatically grouped together based on the geographical proximity of sensors 310A-C at gates 1, 2, and 3 within terminal building 330 of an airport. Furthermore, sensors 312A-C located at a different terminal 332 may not be grouped with sensors 310A-C because of their disparate locations. As another example, sensor data representation module 216 may determine sensors 312A-B are located on the same floor of terminal building 332 and group sensors 312A-B together based on their location metadata, but it may not include sensor 312C because of its location on a different floor, for instance. As another example, sensor data representation module 216 may group sensors, e.g., 310A-C based on determining sensors 310A-C are located within the physical structure of terminal 330 and not select sensor 310D based on determining sensor 310D is located outside of the physical structure of terminal 330. In some embodiments, in certain circumstances sensors within the same airport may be grouped together in order to monitor events at the airport as a whole and not at a more granular level of terminal buildings, gates, etc. It is appreciated that any level of granularity may be achieved and the granularities described herein are for illustrative purposes only and should not be construed as limiting the embodiments.

As described above, metadata associated with sensors 310A-C including location, etc., may be used by sensor data representation module 216 for determining sensor groupings. As illustrated in FIG. 3B, sensor data representation module 216 may group together sensors 312A-B on different floors of building 332. As another example, sensors 312A-B may be grouped together to strategically monitor areas of building 332 previously determined to be vulnerable to intrusion. As yet another example, sensors 314A and 314B may be grouped together because sensor 314A may be an image sensor configured to record still or video images of a ground floor entrance to building 334 and sensor 314B may be an image sensor covering a stairwell on the top floor of building 334. In other words, sensors may be grouped together based on the interrelationships between sensors. For example, sensors 314A-C in buildings 334 and 336 may be grouped together based on the sensors belonging to the same organization (e.g., private security firm).

In some embodiments, sensors may be grouped together based on data from state change manager 208. Examples of data from state manager 208 may include alerts of elevated readings received from one or more sensors. In some embodiments, state change manager 208 may determine whether a state of a sensor has changed based on current sensor data or previous sensor data. As an example, sensors, 310A-D may have five possible states: calibration, nominal, elevated, potential, or warning. Changes in the state of sensors 310A-D may be determined based on the readings of sensors 310A-D being above a threshold, within or outside of a range, etc. As illustrated in FIG. 3C, state change manager 208 may be configured to detect a change in the status of sensors 310A-D (e.g., from nominal to elevated) and sensor data representation module 216 may group sensors 310A-D together. In some embodiments, state change manager 208 may include a state table which is maintained to monitor the state of sensors 310A-D. State change manager 208 may thus provide real-time sensing information based on sensor state changes. In some embodiments, sensor data representation module 216 may group sensors 310A-D based on sensors having a change of status and data of grouped sensors 310A-D may be sent from data store 206 to sensor data representation module 216 (e.g., on a per sensor basis). It is appreciated that the grouping may be based on sensors maintaining certain conditions, e.g., sensors that are elevated remain in the elevated state. For example, heat sensors with readings that are elevated over a period of time (e.g., 2 minutes) may be indicative of a fire and the sensors may be grouped together.

It is appreciated that the grouping of sensors can be used to provide a more accurate and precise picture of events happening. For example, a change of sensor state of a sensor may be a caused fluke or a blip in a single sensor reading. However, when a sensor captures multiple elevated readings or multiple sensors have elevated readings, there is a higher probability of an event taking place. A change of sensor state of multiple sensors may indicate an event occurred that may warrant further attention and sensor data representation module 216 may group sensors 310A-D in response to the elevated readings. As an example, elevated readings from radiation sensors 310A-D with a change of status from nominal to elevated may indicate that radioactive material is present. In some embodiments, the sensor data representation module 216 may automatically identify and group sensors 310A-D together, such that the metadata and sensed data from sensors 310A-D are stored in a data structure of data store 206. As another example, readings from thermal sensors 314A-B within a same area or facility 334 may be grouped together based on change of status from nominal to elevated. The change in status of sensors 314A-B may indicate that a fire or ignition source is present in building 334.

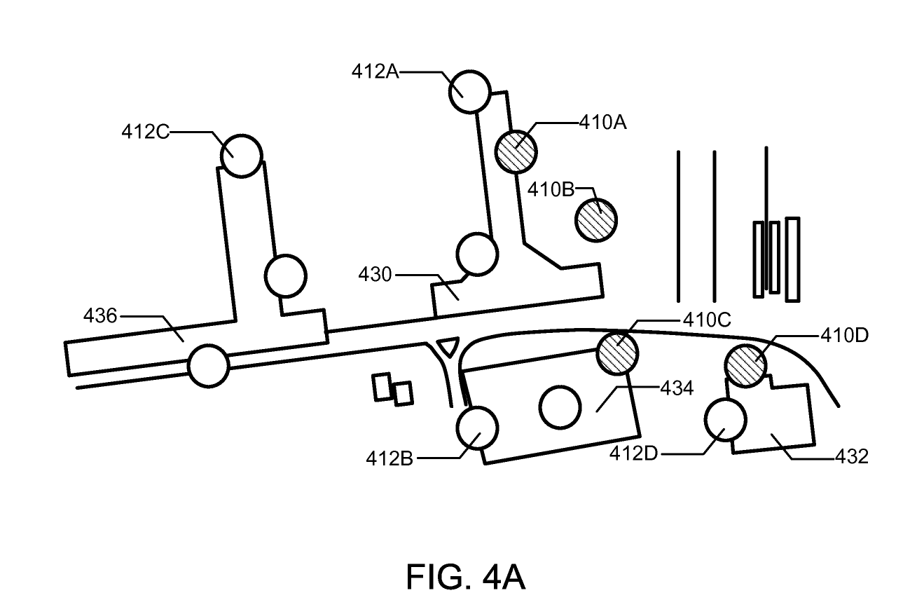

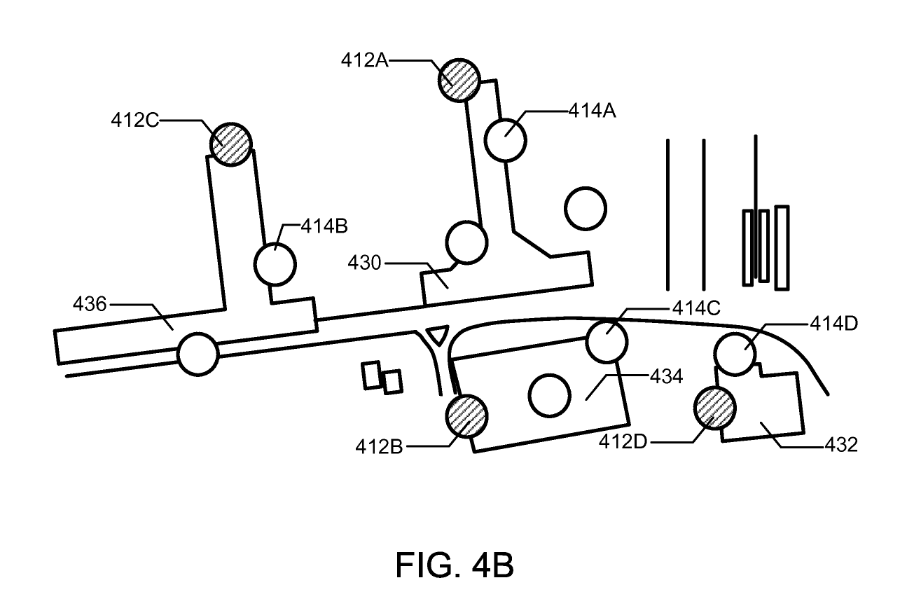

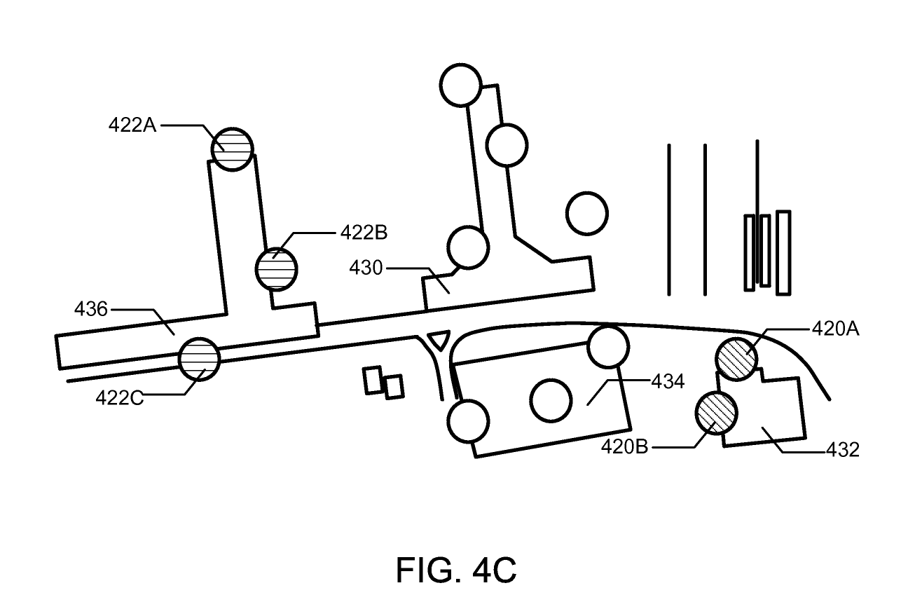

FIGS. 4A-C illustrate other automated groupings of sensors according to some embodiments. In some embodiments, sensors may be grouped based on the data or readings of sensors being within a range of values. For example, a grouping of sensors may be created from sensors 410A-D located within a suitable distance from one another and each sensor 410A-D having elevated sensor readings. The heuristics used to determine the sensor grouping may further include a distance between the sensors and the time of the elevated readings. For example, sensors 410A-410D may be grouped together if adjacent radiation sensors (e.g., 410A to 410B, 410B to 410C, 410C to 410D) are sufficiently distant from each other so that radioactive material may not simultaneously set off all sensors but each of those sensors is set off within a particular time interval, e.g., within a 3 minute interval, of another sensor grouped therein. This might be an indication that a radioactive material is being transported from proximity to sensors 410A to 410B to 410C and finally to 410D. As such, sensors 410A-D may be grouped together based on elevated readings occurring in a particular order (e.g., from 410A to 410D) within a time period between elevated readings (e.g., 10 minutes).

In some embodiments, the grouping of sensors may correspond to an inferred path of a moving radiation source. The heuristics may be based on an inferred time of travel between sensors (e.g., 410C-D), as illustrated in FIG. 4A. For example, sensor data representation module 216 may infer a path of interest based on elevated readings captured by sensors 410A-C and create an initial grouping that includes sensors 410A-C. Subsequently sensor 410D may be added to the grouping based on the distance between sensors 410C-D and the path inferred from the elevated readings of sensors 410A-C. For example, sensor data representation module 216 may identify and add sensor 410D to the sensor grouping based on general direction of the inferred path and that is located within a distance from sensor 410C with the most recent elevated reading.

As described above, sensors may be grouped based on the metadata of the sensors. In some embodiments, sensor data representation module 216 may group sensors 410A-D in disparate locations based on the type of sensor 412A-D, as illustrated by FIG. 4B. In one instance, sensors 412A-D, in buildings 430-436 may be radiation detectors that are grouped together, while other sensors 414A-D, for example, may be another type of sensors that are left out of the grouping. In some embodiments, radiation sensors 414A-D may be monitored by the same organization, for example a nuclear regulatory authority.

In some embodiments, sensor based detection system 102 may create an event to facilitate monitoring the readings of the grouped sensors. Sensor process manager 204 may configure thresholds, ranges, etc. that are compared against sensor readings to determine whether a grouping should be created, as illustrated in FIG. 4C. As an example, a code red event may be created when sensors 420A-B have sensor readings that are at least 40% above historical values. In a case where a geographic location (e.g. 432) may be associated with a third-party entity, data of the event may be sent to the third-party entity for event monitoring. For example, geographic location 432 may be a warehouse that is managed by private security firm and geographic location 432 may have sensors 420A-B monitoring various activities at the location. Sensor based detection system 102 may create an event based on one or more of the grouped sensors 420A-B of geographic location 432 having an elevated reading as described above. The private security firm may then monitor the readings of the grouped sensors 420A-B to evaluate the situation.

As another example, geographic location 436 may be an airport terminal managed by an airport authority. The airport authority may group motion sensors 422A-C together to monitor activity at airport terminal 436. In some embodiments, sensor based detection system 102 may create an event based on the grouped motion sensors 422A-C of geographic location 436 detecting movement during off-hours and the event sent to the airport authority for subsequent monitoring.

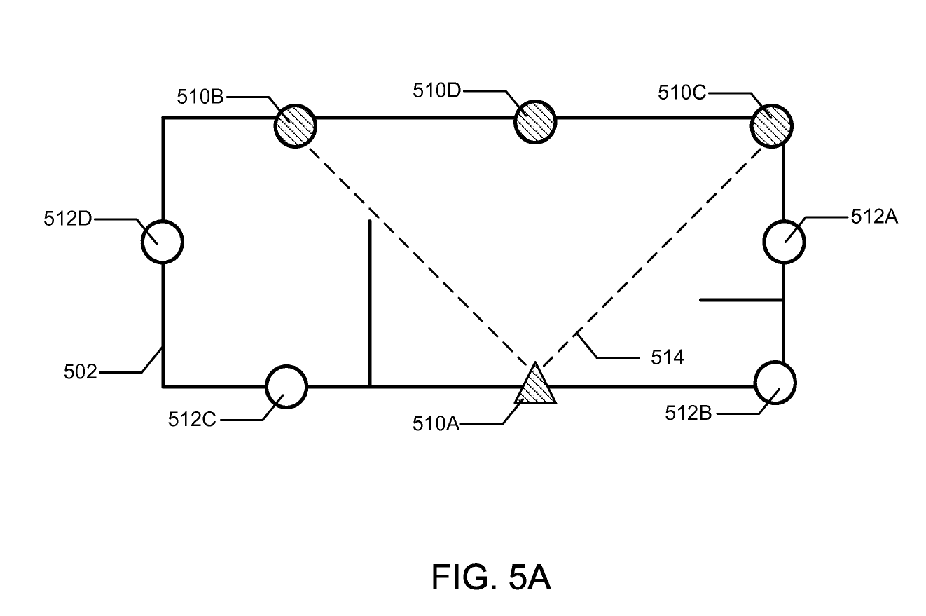

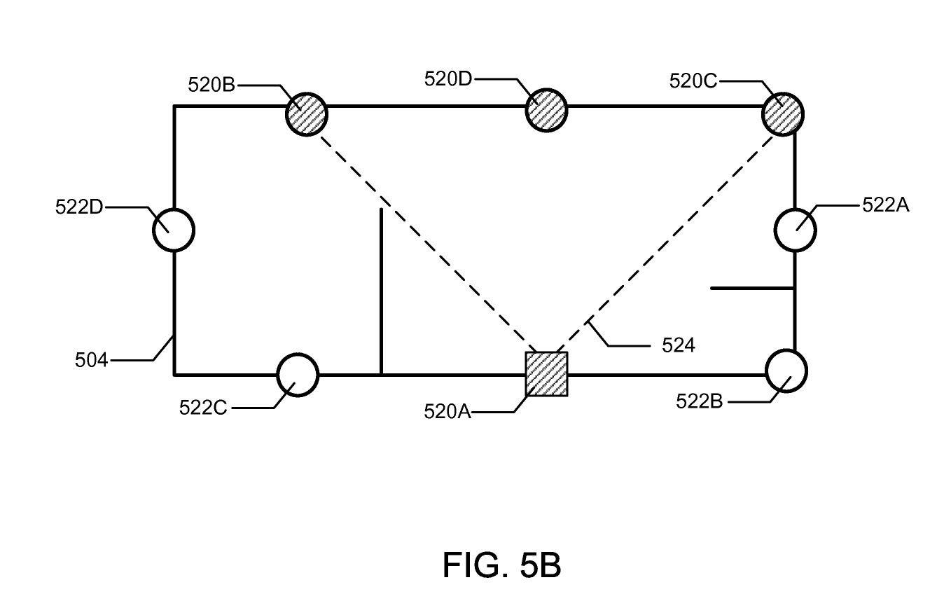

FIGS. 5A-B illustrate other automated groupings of sensors according to some embodiments. As described above, sensor data representation module 216 may group sensors based on the metadata of sensors 510A-D. In some embodiments, sensors 510A-D may be grouped together by identifying and grouping sensors 510A-D that capture complementary data. As illustrated in FIG. 5A, a private security responsible for a museum building 502 may have sensors 510A-D and 512A-D monitoring activity within museum building 502. Sensor 510A may be a motion sensor that is configured to detect motion within an area of coverage illustrated by 514. In some embodiments, sensor data representation module 216 may group thermal sensors 510B-C that are located within area of coverage 514 together with motion sensor 510A. Readings from the grouping of motion sensor 510A with the data from thermal sensors 510B-C may confirm the detection of an intruder by motion sensor 510A in museum building 502. In addition, sensor data representation module 216 may also add image sensor 510D to access video data to identify the intruder. Furthermore, sensors 512A-D located outside of the area of coverage of sensor 510A may be excluded from the sensor grouping.

As illustrated in FIG. 5B, building 504 may be a nuclear storage facility with sensors 520A-D and 522A-D configured to monitor possible movement of radioactive material away from a storage area within building 504. Sensor data representation module 216 may group a motion sensor 520A, having an associated area of coverage 524, with radiation sensors 520B-D. By grouping sensors 520A-D of different types (e.g., radiation and motion), a responsible organization may use one type of data (e.g., radiation) to confirm an elevated reading from another type of data (e.g., motion) and decrease the likelihood of a false positive reading. As an example, motion sensor 520A may detect unauthorized movement around storage area of building 504 and radiation sensors 520B-D may be used to correlate the movement with elevated radiation readings within building 504 as a confirmation of an event requiring the attention of a security organization.

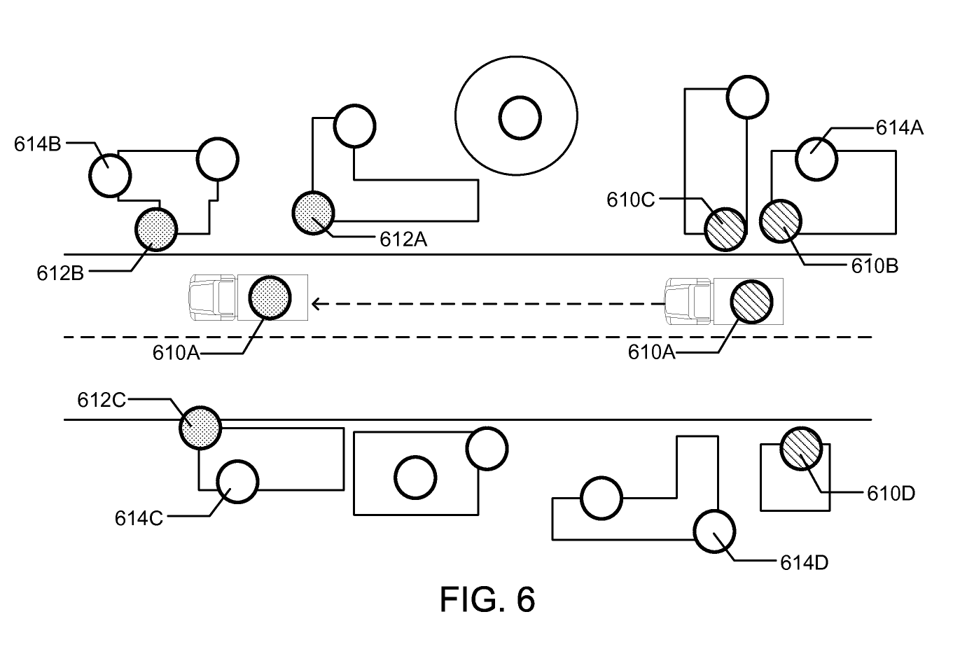

FIG. 6 illustrates another automated grouping of sensors according to some embodiments. As described above, sensor 610A may be a mobile sensor mounted on a vehicle. In one illustrative example, the mobile sensor may be a wireless cell phone equipped with a CMOS chip that can detect gamma radiation. In some embodiments, sensor data representation module 216 may dynamically group and ungroup sensors based on the current position of mobile sensor 610A. As an example, mobile sensor 610A may capture an elevated reading and sensors 610B-D at fixed locations may be grouped together with mobile sensor 610A. In some embodiments, fixed sensors 610B-D may all be within a distance from mobile sensor 610A or have an area of coverage that includes the current location of mobile sensor 610A. Furthermore, sensors (e.g., 614A-D) that are located farther than the distance from mobile sensor 610A may not be grouped with mobile sensor 610A. As the position of mobile sensor 610A changes, sensors 612A-C within the distance from the current location of mobile sensor 610A may be added to the grouping. At the same time, fixed sensors 610B-D that are no longer in proximity to mobile sensor 610A may be ungrouped from mobile sensor 610A. As an example, sensor 610 A may be a mobile radiation and sensors 610B-D and 612A-C may be image sensors for identifying possible suspects carrying radioactive material.

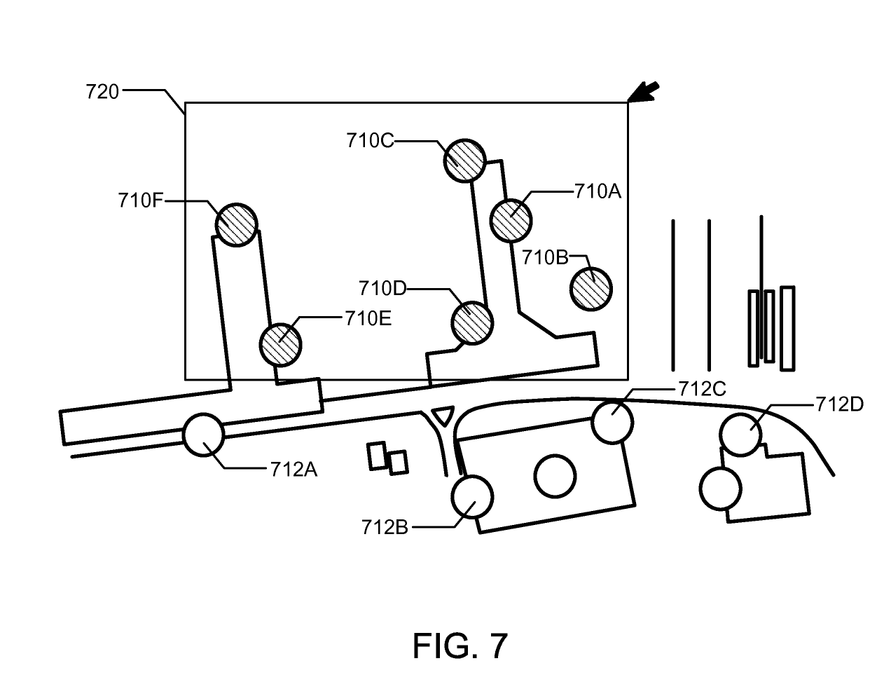

FIG. 7 illustrates a manual grouping of sensors according to some embodiments. As described above, sensors may be visually represented through a graphical element (e.g., icons, images, shapes etc.) on a GUI. In some embodiments, the GUI may display sensors on a map and the GUI may be operable to group sensors 710A-F together through manual selection. For example, sensors 710A-F displayed on a map of a GUI may be grouped through a click and drag selection using a mouse or other input device to form a box 720 around sensors 710A-F. Furthermore, one or more sensors 710A-F may be ungrouped by a click selection of the graphical element representing one or more of the grouped sensors 710A-F. Sensors 712A-D not selected are left out of the grouping of sensors 710A-F. As an example, sensors 710A-F may be grouped by an operator using a GUI (e.g., via lasso selection, click and drag selection, click selection, command line, free text box, etc.). The grouping may be used to display information associated with the sensors within that group. In one example, the grouping may be used to monitor an area of interest of an airport. As another example, an operator may manually group sensors 710A-F that have similar historical readings (e.g., mSv values), such that a uniform condition (e.g., threshold level) may be applied to each sensor 710A-F in the grouping. It is appreciated that the sensors may be grouped, as desired, by the operator as his favorite sensors.

As described above, alerts or readings from the manually grouped sensors 710A-F may then be displayed or sent to a responsible organization as an event. A condition may be applied to the manual grouping of sensors 710A-F, such that an event is triggered based on one or more of the sensors in the group of sensors 710A-F satisfying the condition (e.g., reaching particular reading level, exceeding a range of reading levels, etc.). According to some embodiments, the conditions may be set manually via a GUI by a user or it may be via heuristics. It is appreciated that the selected sensors 710A-F may be of varying types, each with their own conditions appropriate for the type of sensor 710A-F of the grouping.

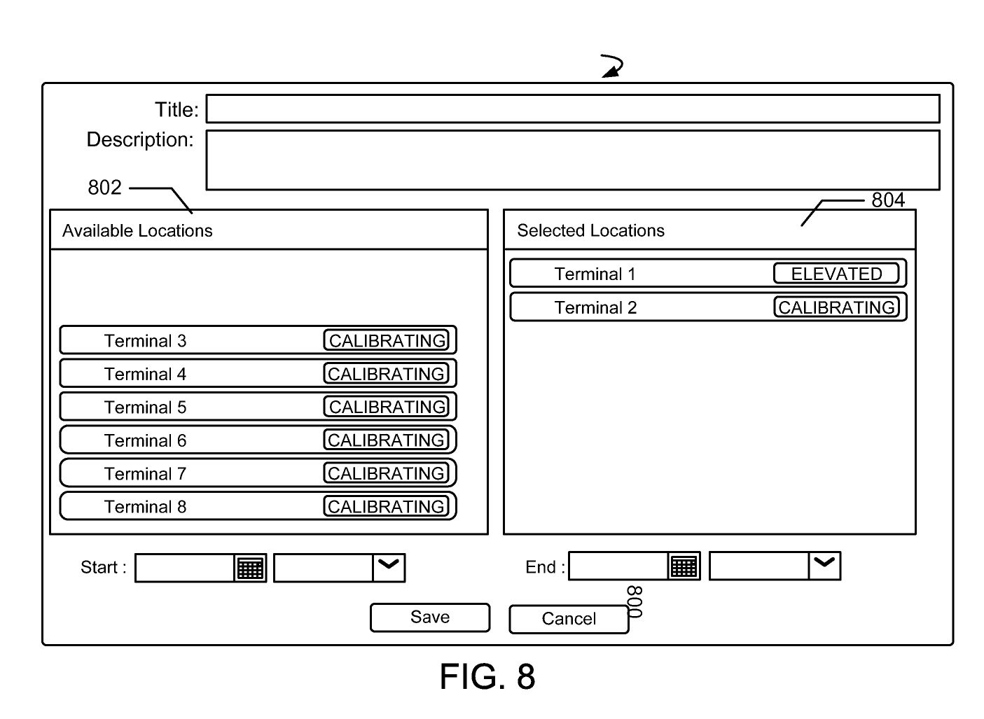

FIG. 8 illustrates another manual grouping of sensors according to some embodiments. Although this disclosure describes and illustrates a GUI configured to manually group sensors using certain methods, this disclosure contemplates any suitable GUI configured for manual grouping of sensors using any suitable methods. In some embodiments, an operator may create a grouping of sensors through a GUI that may include a listing of available sensors. An example wireframe 800 of a GUI may include a listing of locations with sensors 802 and a listing of locations with sensors that have been grouped 804. In some embodiments, an operator may move one or more locations from the listing of available locations 802 to the listing of selected locations 804 by selecting (e.g., click selection) one or more available locations 802 listed in the GUI. In other embodiments, the operator may ungroup the sensors from the selected locations 804 by selecting (e.g., click selection) one or more of the listed selected locations 804. The GUI may further be configured to create an event for the sensors of the grouped locations 804 with a configurable start or end time.

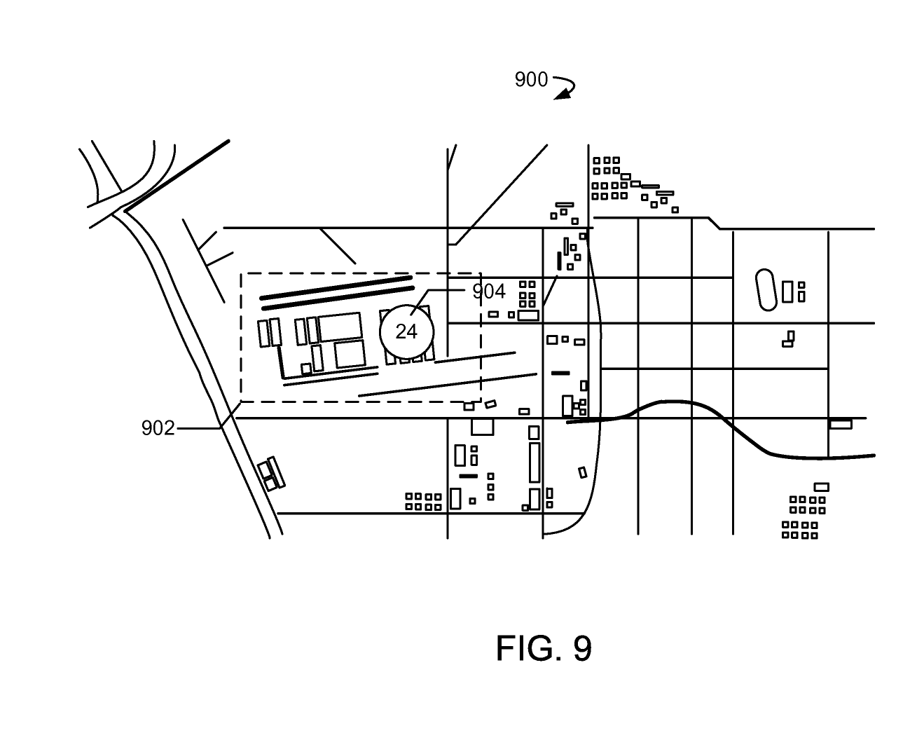

FIGS. 9-11 illustrate map views for sensors according to some embodiments. As described above, sensor based detection system 102 may provide a graphical user interface (GUI) to monitor and manage each of the deployed sensors. The GUI may be configured to provide a map view 900 allowing monitoring of each sensor in a geographical context and may further be used to zoom in and out or enlarge or reduce the view of a group of sensors, e.g., sensors of a geographic location 902. For example, map view 900 may be enlarged or reduced using a graphical element, for example a slider, such that map view 900 may be displayed as granular as desired by the operator. It is appreciated that map view 900 may be a maximum zoom out that includes geographic location 902. For example, map view 900 may display data associated with sensors within an airport 902. In some embodiments, map view 900 may include a graphical element 904, for example an icon, that displays data associated with the sensors. As an example, graphical element 904 may indicate the number of sensors within geographic location 902. As described below, additional graphical elements, for example a pop-up window, may provide additional information about the sensors in response to the operator interacting with graphical element 904. Although this disclosure illustrates and describes map views having exemplary configurations of graphical elements, this disclosure contemplates any suitable map view having any suitable configuration of graphical elements.

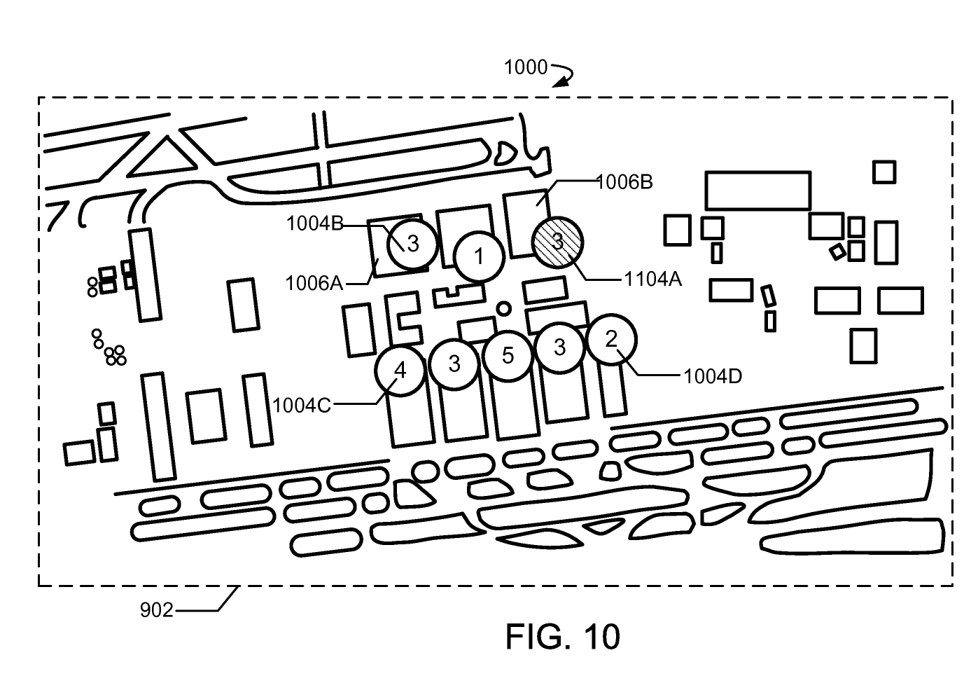

Map view 900 of geographic location 902 may be enlarged or zoomed in to display a map view 1000 of geographic location 902 in more detail. As illustrated in FIG. 10, geographic location 902 may include buildings 1006A-B, for example airport terminals, and graphical elements 1004A-D that display information about the sensors in each building (e.g., 1006A-B) of geographic location 902. Graphical elements 1004A-D may illustrate groupings of sensors, the number of sensors located within each building (e.g., 1006A-B), information about a state of the sensors, status of the sensor, reading of the sensor, metadata associated with the sensor, geo-positional location of the sensor, etc. For example, graphical element 1004B-D may indicate the associated sensors have a nominal status, whilst graphical element 1004A may provide a visual indication that the associated sensors have elevated readings. As described above, sensors with a status indicated elevated readings may include readings that are higher than a threshold value or outside a range of values. As an example, sensors indicated by graphical elements 1004A may be grouped together. As another example, sensors indicated by graphical element 1004B may be grouped together with the sensors of graphical element 1004A by selecting (e.g., click selection) graphical element 1004B.

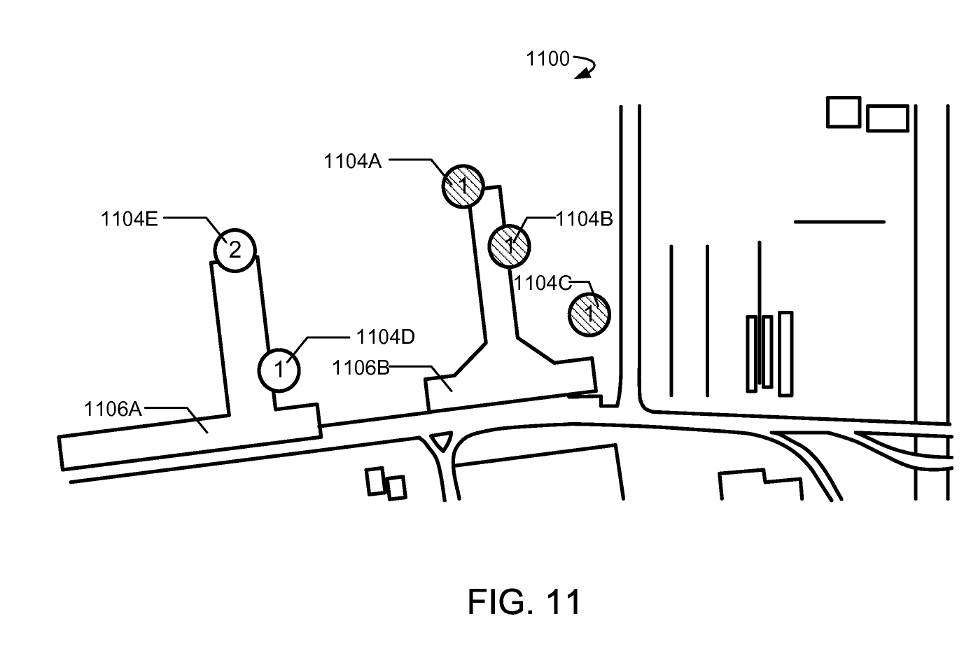

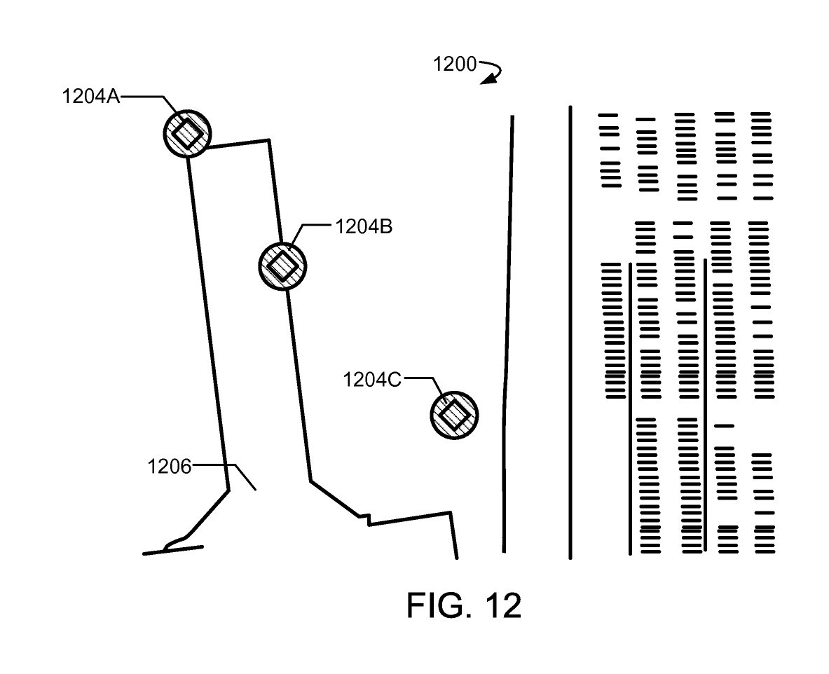

Map view 1000 may be enlarged or zoomed in to display a map view 1100 of the geographic location in more detail, as illustrated in FIG. 11. The shape of buildings 1106A-B, for example airport terminals, may be displayed with more detail and the placement of graphical elements 1104A-E may correspond to the location of the sensors within each building 1106A-B. As described above, graphical elements 1104A-E may display information associated with the number of sensors located within each building 1106A-B, an alert level of the sensors, status of the sensor, reading of the sensor, type of sensor, geo-positional location of the sensor, the organization that owns or is responsible for the sensors, etc. For example, a number associated with graphical elements 1104A-E may indicate the number of sensors with those geographic coordinates, for example latitude and longitude. As another example, a number associated with graphical elements 1104A-E may indicate the sensors have an elevated reading. Graphical elements 1104A-E having number greater than 1 may indicate multiple sensors with the same geographic coordinates, but differing geodetic heights, for example different floors of building 1106A-B. Map view 1100 may be enlarged or zoomed in to display a map view 1200 of the geographic location with additional detail, as illustrated in FIG. 12. Building 1106 and its surrounding area may be displayed with more detail and the placement of graphical elements 1204A-C may correspond to the location and state of each sensor of building 1206.

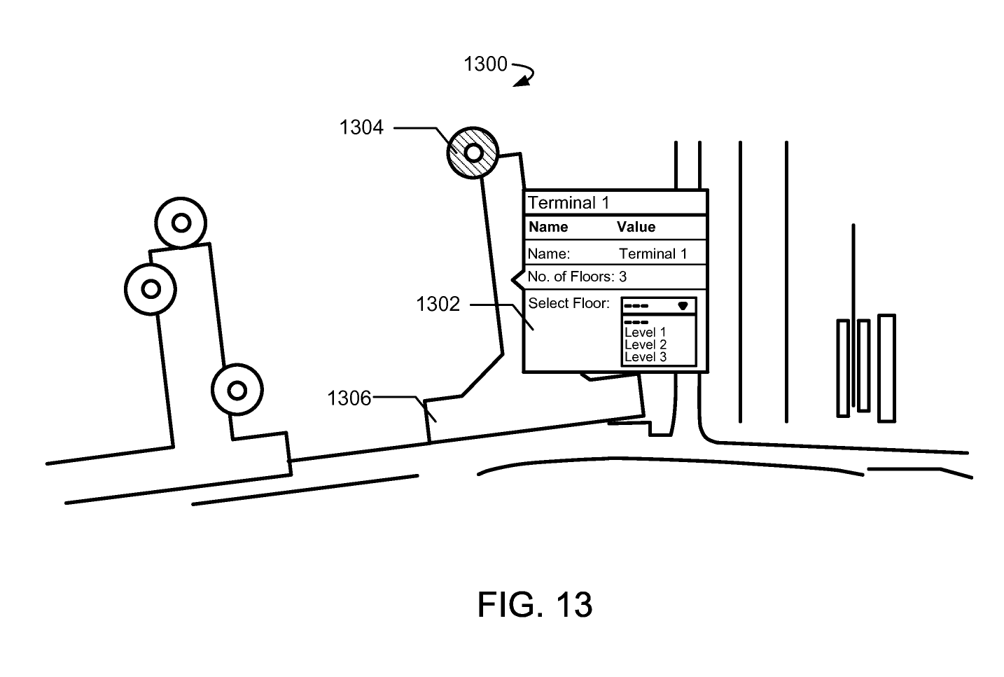

As described above, the GUI may also be used to render information in response to a user interaction. As illustrated in FIG. 13, information associated with building 1306 may be rendered or displayed in map view 1300 in response to the user interaction. Example information of building 1306 may include a name, geographical coordinates, address, number of floors, physical size, dimensions, responsible entity, type of building, etc. For example, pop-up window 1302 displaying information of building 1306 may be rendered in map view 1300 in response to detecting that the user has moved the cursor over building 1306. Pop-up window 1302 may include a drop-down menu to display an icon 1304 illustrating the location of sensors in different parts of building 1306, e.g., floors. In some embodiments, pop-up window 1302 may include a menu configured to allow an operator to manually group or ungroup one or more sensors of building 1306 to a grouping of sensors. In some embodiments, additional information may be rendered in response to a user selection. For example, information regarding a sensor in terminal A may be displayed in response to a user selection of the sensor. Similarly, information regarding a group of sensors may be displayed in response to a user selection of the group.

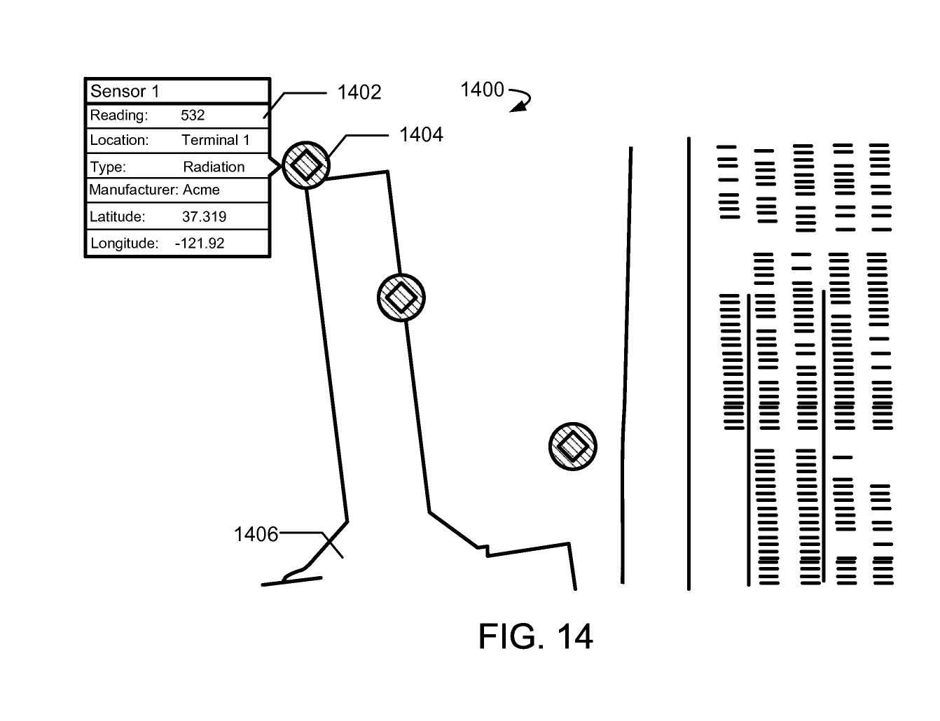

As illustrated in FIG. 14, information of sensor 1404 of building 1406 may be rendered or displayed in map view 1400 in response to the user interaction. Example information about sensor associated with graphical elements 1404 may include data of the sensor (e.g., reading) or metadata of the sensor, for example a name, type of sensor, manufacturer, location name, geographic coordinates, address, etc. For example, pop-up window 1402 displaying information about sensor associated with graphical element 1404 may be rendered in map view 1400 in response to detecting the user has moved the cursor over icon 1404 or that a user has selected icon 1404. Furthermore, pop-up window 1402 may include a listing of sensors grouped with sensor 1404.

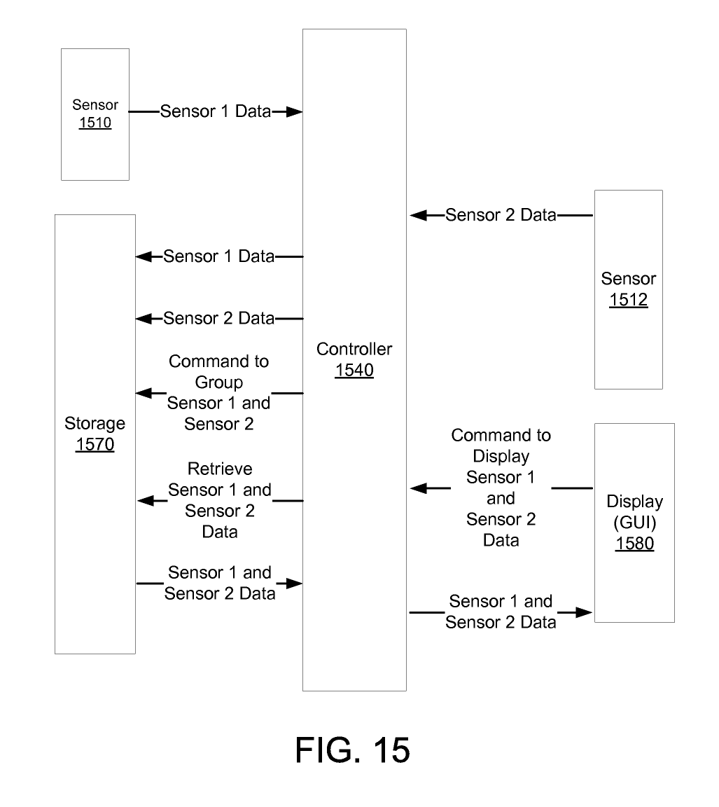

FIG. 15 illustrates data interactions within a sensor based detection system according to some embodiments. In some embodiments, a controller 1540 of sensor based detection system 102 may receive data from sensors 1510-1512. Data from sensors 1510-1512 may be stored on storage 1570. As an example, storage 1570 may include data store 206. In some embodiments, controller 1540 may automatically group together sensors 1510-1512. As an example, sensors 1510-1512 may be grouped together based on heuristics, for example readings above a certain threshold. Furthermore, data of the grouped sensors 1510-1512 may be stored on storage 1570 in a dynamic data structure. An operator may interact with controller 1540 through a GUI rendered on display 1580 and through the GUI request data of sensors 1510-1512. It is appreciated that the operator interaction may be hovering the cursor over a group of sensors, selecting the group, selecting a geographical position associated with a sensor or group of sensors, etc. A command may be sent through the GUI to controller 1540 to retrieve the data of sensors 1510-1512. Controller 1540 may access the data of sensors 1510-1512 stored on storage 1570 and send the sensor data to display 1570. In one instance, data of sensors 1510-1512 may be rendered by the GUI.

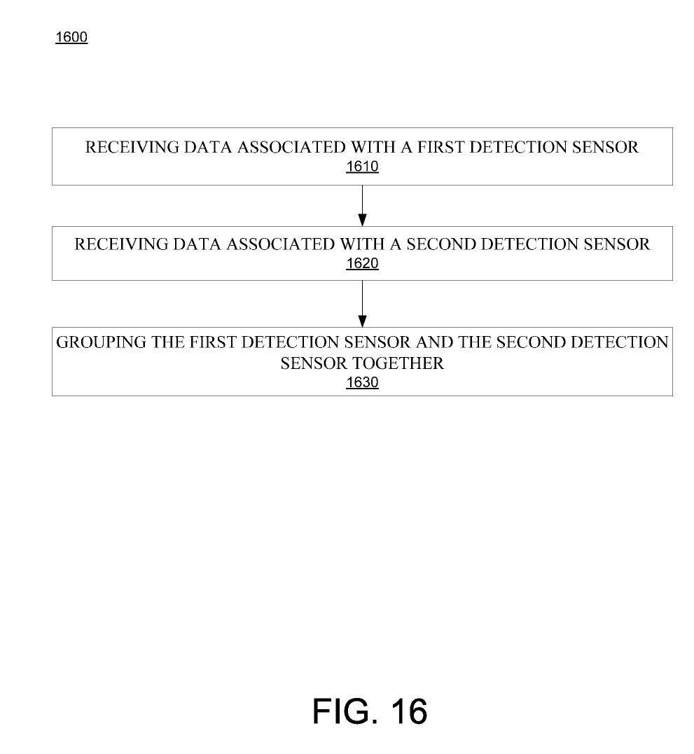

FIG. 16 illustrates a flow chart diagram 1600 for grouping sensors according to some embodiments. At step 1610, data associated with a first detection sensor is received. As illustrated in FIG. 1, sensor based detection system 102 may receive data from sensors 110-114 through network 106. At step 1620, data associated with a second detection sensor is received. As described above, the first and second detection sensors may be a thermal, electromagnetic, light, image, particle, Geiger counter, mechanical, biological, chemical sensor, or any combination thereof. At step 1630, the first detection sensor and the second detection sensor are grouped together. In particular embodiments, the grouping is performed based on data associated with the first detection sensor and the second detection sensor satisfying a certain condition. For example, the certain condition may be that the first detection sensor and the second detection sensor being within a certain distance to one another. As another example, the certain condition may be whether a reading associated with the first detection sensor is within a first given threshold and a reading associated with the second detection sensor is within a second given threshold.

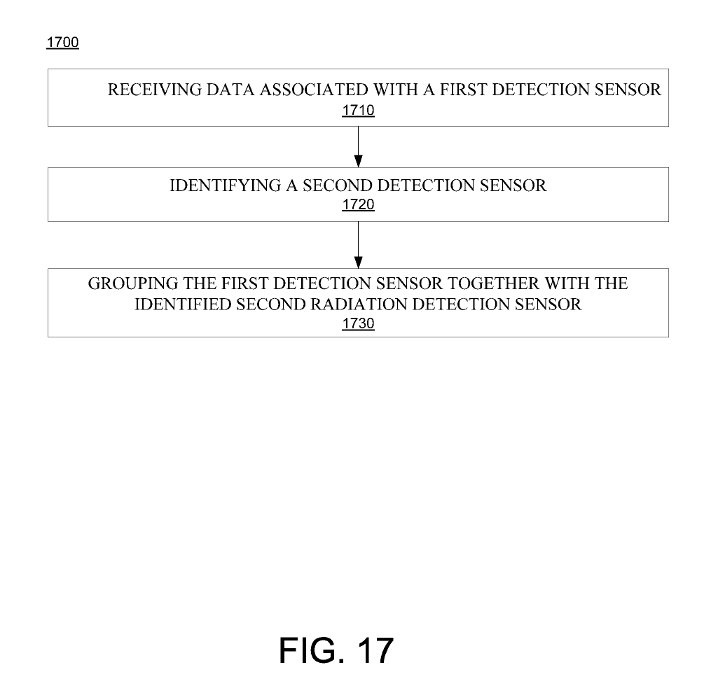

FIG. 17 illustrates another flow chart diagram 1700 for grouping sensors according to some embodiments. At step 1710, data associated with a first detection sensor is received. As illustrated in FIG. 1, sensor based detection system 102 may receive data from sensors 110-114 through network 106. At step 1720, a second detection sensor is identified based on data second sensor satisfying a certain condition. For example, sensor data representation module 216 may identify the second detection sensor by determining a reading of the second detection sensor is outside a given range of values. As another example, sensor data representation module 216 may identify the second detection sensor by determining the second detection sensor is within a certain distance to the first detection sensor. As another example, sensor data representation module 226 may identify the second detection sensor by determining the second detection sensor is the same type of detection sensor as the first detection sensor, as described in regard to FIG. 4. As another example, sensor data representation module 216 may identify the second detection sensor by determining the second detection sensor is within an area of coverage of the first detection sensor, as described in FIG. 5. At step 1730, the first detection sensor is grouped together with the identified second radiation detection sensor.

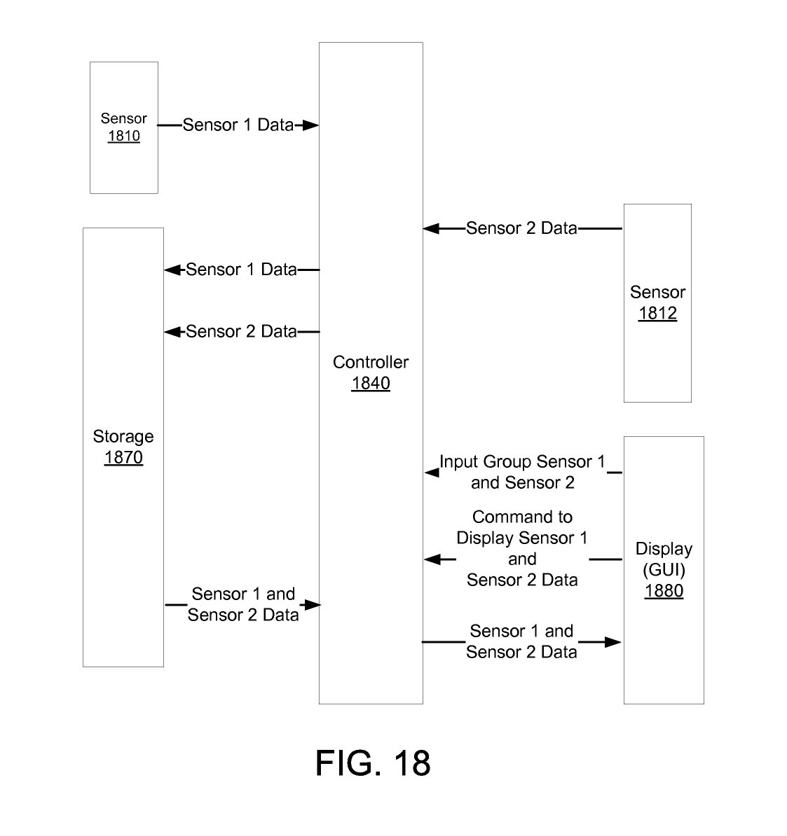

FIG. 18 illustrates other exemplary data interactions within a sensor based detection system according to some embodiments. In some embodiments, a controller 1840 of sensor based detection system 102 may receive data from sensors 1810-1812. Data from sensors 1810-1512 may be stored on storage 1870. As an example, storage 1870 may include data store 206. An operator may interact with controller 1840 through a GUI rendered on display 1880 and through the GUI may manually group together sensors 1810-1812. As an example, the operator may group sensors 1510-1512 together through an interaction with the GUI, for example a click and drag selection. Furthermore, data of the grouped sensors 1810-1812 may be stored on storage 1870 in a data structure. A subsequent command may be sent through the GUI to controller 1840 to retrieve the data of sensors 1810-1812. Controller 1840 may access the data of sensors 1810-1812 stored on storage 1870 and send the sensor data to display 1870. In one instance, data of sensors 1810-1812 may be rendered by the GUI.

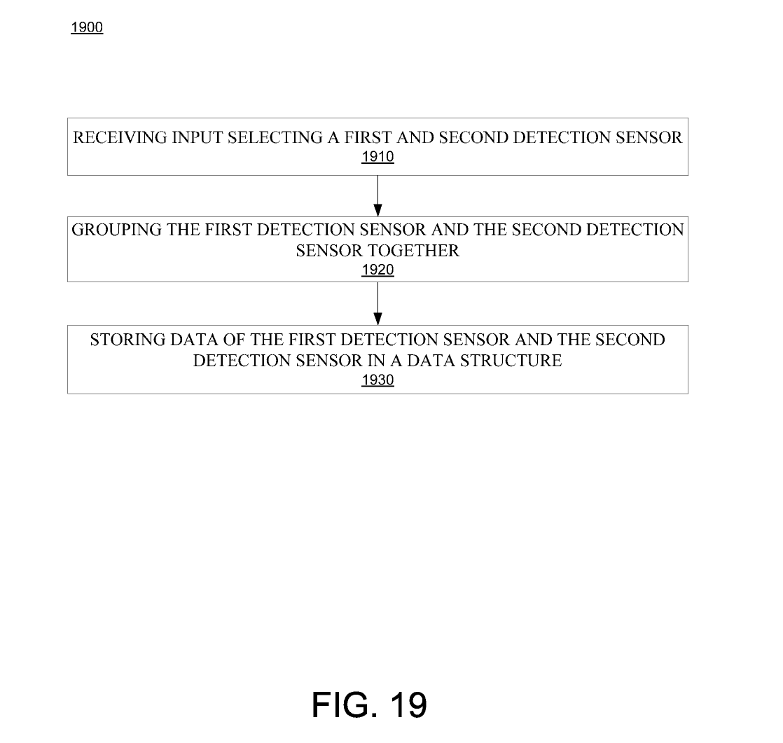

FIG. 19 illustrates a flow chart diagram 1900 for manually grouping sensors according to some embodiments. At step 1910, an input selecting a first detection sensor is received. As described above, the input is a user selection of the first detection sensor and the second detection sensor received via a graphical user interface. In some embodiments, the user selection includes a drag and click selection of the first detection sensor and the second detection sensor received via the graphical user interface. At step 1920, the first detection sensor and the second detection sensor are grouped together in response to receiving the input. At step 1930, data associated with the first and second detection sensors is stored in a data structure. As illustrated in FIG. 1, sensor based detection system 102 may receive data from sensors 110-114 through network 106. As described above, the first and second detection sensors may be a thermal, electromagnetic, light, image, particle, Geiger counter, mechanical, biological, chemical sensor, or any combination thereof.

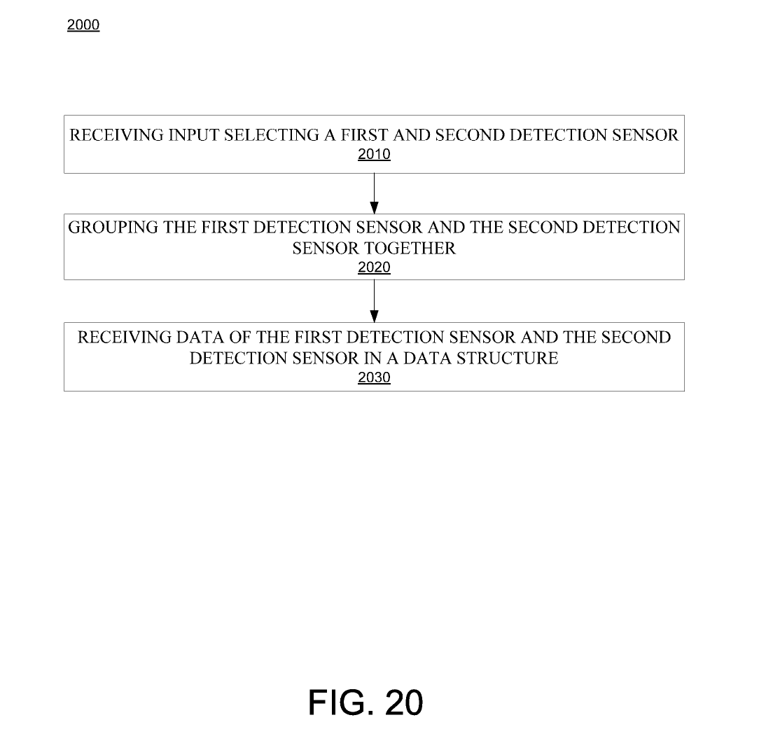

FIG. 20 illustrates another flow chart diagram 2000 for manually grouping sensors according to some embodiments. At step 2010, an input selecting a first detection sensor is received. As described above, the input is a user selection of the first detection sensor and the second detection sensor received via a graphical user interface. In some embodiments, the user selection includes a click selection of the first detection sensor and the second detection sensor on a map overlay rendered on the graphical user interface. At step 2020, the first detection sensor and the second detection sensor are grouped together in response to receiving the input. At step 2030, data associated with the first and second detection sensors is received. As illustrated in the example of FIG. 1, sensor based detection system 102 may receive data from sensors 110-114 through network 106. As described above, the first and second detection sensors may be a thermal, electromagnetic, light, image, particle, Geiger counter, mechanical, biological, chemical sensor, or any combination thereof. In some embodiments, the data of the first and second sensors are stored in a data structure.

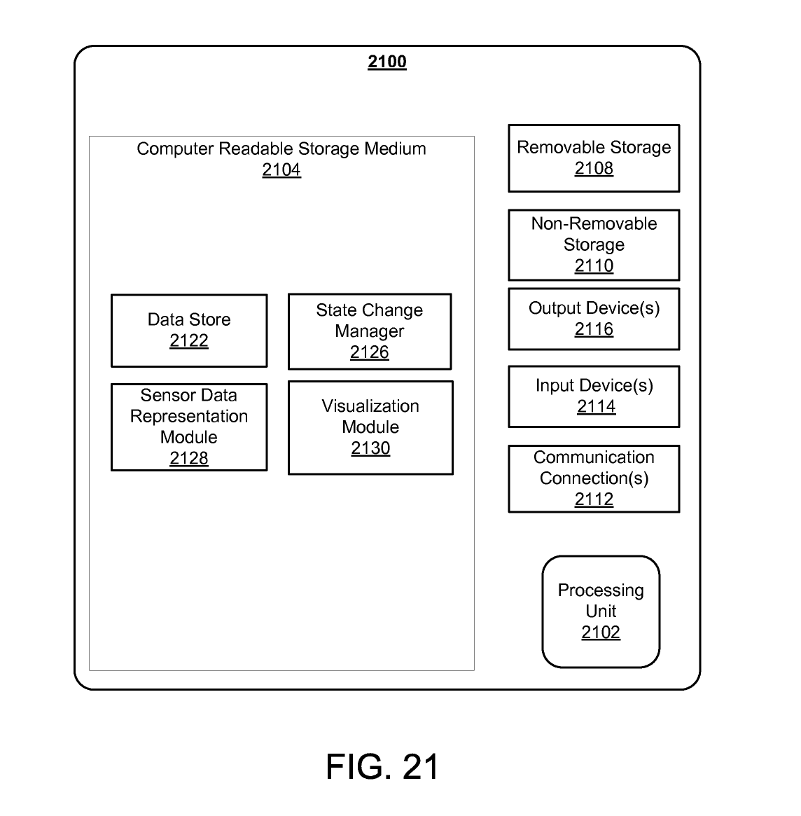

FIG. 21 illustrates a computer system according to some embodiments. As illustrated in FIG. 21, a system module for implementing embodiments includes a general purpose computing system environment, such as computing system environment 2100. Computing system environment 2100 may include, but is not limited to, servers, switches, routers, desktop computers, laptops, tablets, mobile devices, and smartphones. In its most basic configuration, computing system environment 2100 typically includes at least one processing unit 2102 and computer readable storage medium 2104. Depending on the exact configuration and type of computing system environment, computer readable storage medium 2104 may be volatile (such as RAM), non-volatile (such as ROM, flash memory, etc.) or some combination of the two. Portions of computer readable storage medium 2104 when executed manage an event ticket (e.g., processes 1600, 1700, 1900, and 2000).

Additionally, in various embodiments, computing system environment 2100 may also have other features/functionality. For example, computing system environment 2100 may also include additional storage (removable and/or non-removable) including, but not limited to, magnetic or optical disks or tape. Such additional storage is illustrated by removable storage 2108 and non-removable storage 2110. Computer storage media includes volatile and nonvolatile, removable and non-removable media implemented in any method or technology for storage of information such as computer readable instructions, data structures, program modules or other data. Computer readable medium 2104, removable storage 2108 and nonremovable storage 2110 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 2100. Any such computer storage media may be part of computing system environment 2100.

In some embodiments, computing system environment 2100 may also contain communications connection(s) 2112 that allow it to communicate with other devices. Communications connection(s) 2112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 2112 may allow computing system environment 2100 to communicate over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 2112 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 2100 may also have input device(s) 2114 such as keyboard, mouse, a terminal or terminal emulator (either connected or remotely accessible via telnet, SSH, http, SSL, etc.), pen, voice input device, touch input device, remote control, etc. Output device(s) 2116 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 2104 includes a data store 2122, a state change manager 2126, a sensor data representation module 2128, and a visualization module 2130. The data store 2122 may be similar to data store 206 described above and is operable to store data associated with a first and second detection sensor according to flow diagrams 1600, 1700, 1900, and 2000, for instance. The state change manager 2126 may be similar to state change manager 208 described above and may be used to determine whether the data of the first and second radiation detection sensors satisfy a certain condition. The sensor data representation module 2128 may be similar to sensor data representation module 216 described above and may operate to group the first radiation detection sensor and the second radiation detection sensor together based on the determination that the data of the first and second radiation detection sensor satisfy the certain condition, as discussed with respect to flows 1600, 1700, 1900, and 2000. The visualization module 2130 is operable to render a portion of the data associated with the first detection sensor, as discussed with respect to flows 1600, 1700, 1900, and 2000.

It is appreciated that implementations according to embodiments of the present invention that are described with respect to a computer system are merely exemplary and not intended to limit the scope of the present invention. For example, embodiments of the present invention may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 1600, 1700, 1900, and 2000.

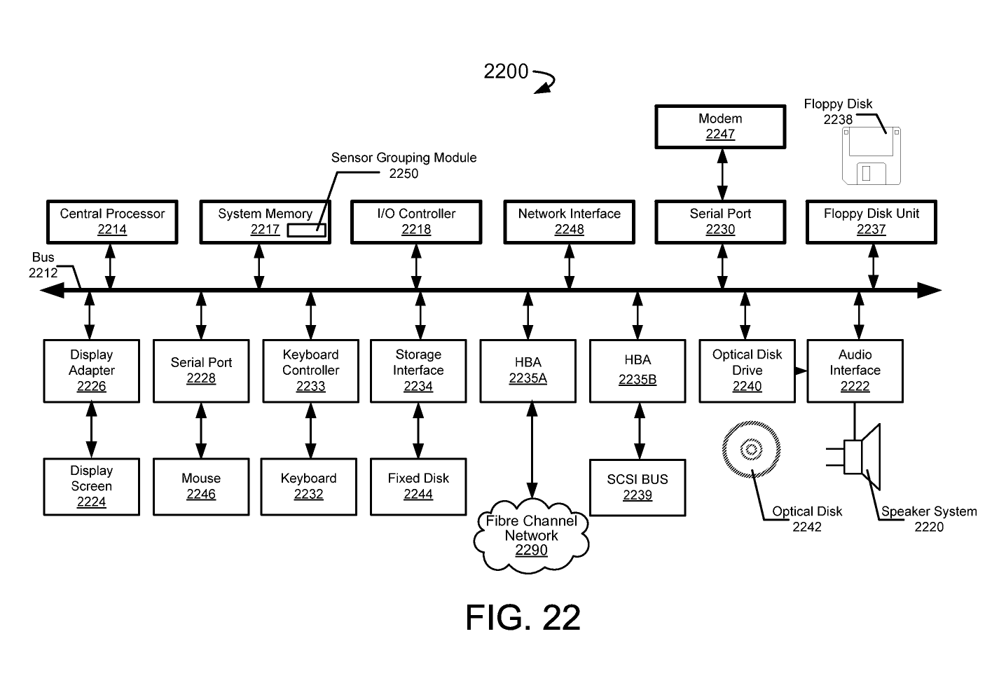

FIG. 22 illustrates a block diagram of another computer system according to some embodiments. FIG. 22 depicts a block diagram of a computer system 2210 suitable for implementing the present disclosure. Computer system 2210 includes a bus 2212 which interconnects major subsystems of computer system 2210, such as a central processor 2214, a system memory 2217 (typically RAM, but which may also include ROM, flash RAM, or the like), an input/output controller 2218, an external audio device, such as a speaker system 2220 via an audio output interface 2222, an external device, such as a display screen 2224 via display adapter 2226, serial ports 2228 and 2230, a keyboard 2232 (interfaced with a keyboard controller 2233), a storage interface 2234, a floppy disk drive 2237 operative to receive a floppy disk 2238, a host bus adapter (HBA) interface card 2235A operative to connect with a Fibre Channel network 2290, a host bus adapter (HBA) interface card 2235B operative to connect to a SCSI bus 2239, and an optical disk drive 2240 operative to receive an optical disk 2242. Also included are a mouse 2246 (or other point-and-click device, coupled to bus 2212 via serial port 2228), a modem 2247 (coupled to bus 2212 via serial port 2230), and a network interface 2248 (coupled directly to bus 2212). It is appreciated that the network interface 2248 may include one or more Ethernet ports, wireless local area network (WLAN) interfaces, etc., but are not limited thereto. System memory 2217 includes a sensor grouping module 2250 which is operable to group sensors based on comparing sensor readings to a condition. According to one embodiment, the sensor grouping module 2250 may include other modules for carrying out various tasks. For example, sensor grouping management module 2250 may include the data store 2122, the state change manager 2126, the sensor data representation module 2128, and the visualization module 2130, as discussed with respect to FIG. 21 above. It is appreciated that the sensor grouping module 2250 may be located anywhere in the system and is not limited to the system memory 2217. As such, residing of the sensor grouping module 2250 within the system memory 2217 is merely exemplary and not intended to limit the scope of the present invention. For example, parts of the sensor grouping module 2250 may reside within the central processor 2214 and/or the network interface 2248 but are not limited thereto.

Bus 2212 allows data communication between central processor 2214 and system memory 2217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 2210 are generally stored on and accessed via a computer readable medium, such as a hard disk drive (e.g., fixed disk 2244), an optical drive (e.g., optical drive 2240), a floppy disk unit 2237, or other storage medium. Additionally, applications can be in the form of electronic signals modulated in accordance with the application and data communication technology when accessed via network modem 2247 or interface 2248.

Storage interface 2234, as with the other storage interfaces of computer system 2210, can connect to a standard computer readable medium for storage and/or retrieval of information, such as a fixed disk drive 2244. Fixed disk drive 2244 may be a part of computer system 2210 or may be separate and accessed through other interface systems. Network interface 2248 may provide multiple connections to other devices. Furthermore, modem 2247 may provide a direct connection to a remote server via a telephone link or to the Internet via an internet service provider (ISP). Network interface 2248 may provide one or more connection to a data network, which may include any number of networked devices. It is appreciated that the connections via the network interface 2248 may be via a direct connection to a remote server via a direct network link to the Internet via a POP (point of presence). Network interface 2248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 22 need not be present to practice the present disclosure. The devices and subsystems can be interconnected in different ways from that shown in FIG. 22. The operation of a computer system such as that shown in FIG. 22 is readily known in the art and is not discussed in detail in this application. Code to implement the present disclosure can be stored in computer-readable storage media such as one or more of system memory 2217, fixed disk 2244, optical disk 2242, or floppy disk 2238. The operating system provided on computer system 2210 may be MS-DOS®, MS-WINDOWS®, OS/2®, UNIX®, LINUX®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method comprising:
receiving data associated with a first detection sensor;
receiving data associated with a second detection sensor; and
grouping the first detection sensor and the second detection sensor together if the data associated with the first detection sensor satisfies a first condition and if the data associated with the second sensor detection sensor satisfies a second condition.

2. The method as described in claim 1, wherein the data associated with the first detection sensor comprises a geo-locational position of the first detection sensor, and wherein the data associated with the second detection sensor comprises a geo-locational position of the second detection sensor.

3. The method as described in claim 1, wherein the data associated with the first detection sensor comprises a reading of the first detection sensor, and wherein the data associated with the second detection sensor comprises a reading of the second detection sensor.

4. The method as described in claim 1, wherein the grouping is further based on the first detection sensor and the second detection sensor being within a certain distance to one another.

5. The method as described in claim 1, wherein the first condition is whether a reading associated with the first detection sensor is within a first given threshold and the second condition is whether a reading associated with the second detection sensor is within a second given threshold.

6. The method as described in claim 5, wherein the first given threshold is same as the second given threshold.

7. The method as described in claim 1, further comprising sending a notification in response to the data associated with the first detection sensor satisfying the first condition or the second detection sensor satisfying the second condition.

8. The method as described in claim 1 further comprising:
rendering a portion of metadata associated with the first detection sensor.

9. The method as described in claim 8, wherein the rendering is responsive to a user manipulation via a graphical user interface.

10. The method as described in claim 1, wherein the certain condition is a user input received via a graphical user interface.

11. A system comprising:
a data store configured to store data associated with a first and second detection sensor;
a state change manager configured to determine whether the data of the first detection sensor satisfies a first condition and the second detection sensor satisfies a second condition; and
a sensor data representation module configured to group the first detection sensor and the second detection sensor together based on the determination that data of the first detection sensor satisfies the first condition and that the data associated with the second sensor detection sensor satisfies the second condition.

12. The system as described in claim 11, wherein the state data representation module is further configured to identify the second detection sensor based on determining the second detection sensor is within a certain distance to the first detection sensor.

13. The system as described in claim 11, wherein the sensor data representation module is further configured to determine is whether a reading associated with the first detection sensor is within a first given threshold and whether a reading associated with the second detection sensor is within a second given threshold.

14. The system as described in claim 11, wherein the sensor data representation module is further configured to group the first and second detection sensors based on determining a path traveled by a hazardous material as determined by the first detection sensor and the second detection sensor.

15. The system as described in claim 11, wherein the sensor data representation module is further configured to ungroup the first detection sensor from the second detection sensor based on detecting the data of the first detection sensor fails to satisfy the first condition.

16. The system as described in claim 11, wherein the sensor data representation module is further configured to detect a user selection of the first detection sensor and the second detection sensor received via a graphical user interface.

17. A method comprising:
receiving data associated with a first detection sensor;
identifying a second detection sensor based on data of the second sensor satisfying a certain condition; and
grouping the first detection sensor together with the identified second detection sensor.

18. The method as described in claim 17, wherein the certain condition is a reading of the second detection sensor is outside a given range of values.

19. The method as described in claim 17, wherein the certain condition is the second detection sensor is within a given distance to the first detection sensor.

20. The method as described in claim 17, wherein the certain condition is the second detection sensor is a same type of detection sensor as the first detection sensor.

21. The method as described in claim 17, wherein the certain condition is the second detection sensor being within a coverage area of the first detection sensor.

22. The method as described in claim 17, further comprising ungrouping the second detection sensor from the first detection sensor based on detecting the data of the second sensor fails to satisfy the certain condition.
